(19) United States
(12) Patent Application Publication
(10) Pub. No.: US 2025/0186881 A1
(43) Pub. Date: Jun. 12, 2025

(54) ENTERTAINMENT SYSTEM, CONTROL METHOD OF ENTERTAINMENT SYSTEM, AND INFORMATION STORAGE MEDIUM

(71) Applicants: Yamaha Hatsudoki Kabushiki Kaisha, Shizuoka (JP); YAMAHA CORPORATION, Hamamatsu-shi (JP); CALIFORNIA INSTITUTE OF TECHNOLOGY, Pasadena, CA (US)

(72) Inventors: Takashi SUEGAMI, Shizuoka (JP); Mark CHANGIZI, Miami, FL (US); Shinsuke SHIMOJO, Pasadena, CA (US); Kazuya WASHIO, Arcadia, CA (US); Yoshihiro KATSUMATA, Hamamatsu-shi (JP); Daw-An Justin WU, Pasadena, CA (US); Amir Vala TAVAKOLI, Santa Monica, CA (US)

(21) Appl. No.: 18/974,842

(22) Filed: Dec. 10, 2024

Related U.S. Application Data
(60) Provisional application No. 63/608,322, filed on Dec. 11, 2023.

(51) Int. Cl. A63F 13/25

(52) U.S. Cl. CPC A63F 13/25

(57) ABSTRACT

An entertainment system generates a tone mark in response to a tone mark generating operation performed by a first player, move the tone mark toward a second player area, generates a tone mark in response to a tone mark generating operation performed by a second player, and moves the tone mark toward a first player area. When the tone mark generated by the second player arrives at the first player area, whether the first player performs a tone output operation is determined. When the tone mark generated by the first player arrives at the second player area, whether the second player performs a tone output operation is determined. Communication points are calculated based on the tone mark generating operation and the tone output operation by the first player and the tone mark generating operation and the tone output operation by the second player.

### CROSS-REFERENCE TO RELATED APPLICATION

The present application claims priority from U.S. provisional application 63/608,322 filed on Dec. 11, 2023, the content of which is hereby incorporated by reference into this application.

### BACKGROUND OF THE INVENTION

### 1. Field of the Invention

The present disclosure relates to an entertainment system, a method for controlling an entertainment system, and a program.

### 2. Description of the Related Art

JP2003-236243A and JP2003-236237A disclose a game in which a light shot is moved between a plurality of players in accordance with background music. Each player needs to timely bounce back the light shot that arrives in their own area. The game is configured such that the background music is disturbed when the player cannot timely bounce back the light shot. The players try to timely bounce back the light shot that has arrived in their areas so as to maintain the background music.

### SUMMARY OF THE INVENTION

### Technical Problem

If each player can feel the intention of other players or feel that other players recognize the player's intention through the game, communication between players can be achieved through the game, which may provide great emotion and excitement. Conventional game devices have room for improvement in terms of such communication between players.

### Solution to Problem

(1) An entertainment system proposed in the present disclosure includes a first display control unit that generates a tone mark on a display screen in response to a tone mark generating operation by a first player and moves the tone mark toward a second player area provided on the display screen, a second display control unit that generates a tone mark on the display screen in response to a tone mark generating operation by a second player and moves the tone mark toward a first player area provided on the display screen, a first determining unit that determines whether the first player performs a tone output operation at a time when the tone mark generated by the second player arrives at the first player area, a second determining unit that determines whether the second player performs a tone output operation at a time when the tone mark generated by the first player arrives at the second player area, and an evaluating unit that calculates an amount of communication points based on at least one of the tone mark generating operation or the tone output operation by the first player and at least one of the tone mark generating operation or the tone output operation by the second player.

According to the entertainment system, the tone mark generated by the first player moves to the second player area and the tone mark generated by the second player moves to the first player area. This allows, for example, the second player to feel the rhythm of the movement of the first player (generation of the tone mark) and the first player to feel the rhythm of the movement of the second player (generation of the tone mark). This enables communication between the first player and the second player via the tone mark.

(2) The entertainment system of (1) may further include a communication quantity expressing unit that controls a background including at least one of sound or video based on the communication point, the sound being output from an audio output unit, the video being displayed on the display screen. This enables the two players to feel a change in sound or video, thereby recognizing lack of communication.

(3) In the entertainment system of (1) or (2), the tone mark generating operation by the first player may be a touch operation on the first player area, and the tone mark generating operation by the second player may be a touch operation on the second player area.

(4) In the entertainment system according to any one of (1) to (3), the tone output operation by the first player may be a touch operation on the tone mark that arrives at the first player area, and the tone output operation by the second player may be a touch operation on the tone mark that arrives at the second player area.

(5) In the entertainment system according to any one of (1) to (4), the evaluating unit may compare at least one of the tone mark generating operation or the tone output operation by the first player and at least one of the tone mark generating operation or the tone output operation by the second player, and calculate the communication points based on a result of the comparison. In this manner, the communication points can be increased when the movements (operations) of the two players are balanced, and the communication can be appropriately evaluated.

(6) In the entertainment system according to any one of (1) to (5), the evaluating unit may calculate the communication points based on a difference or a ratio between a value corresponding to a count of at least one of the tone mark generating operation or the tone output operation by the first player and a value corresponding to a count of at least one of the tone mark generating operation and the tone output operation by the second player. In this manner, the communication points can be increased when the movements (operations) of the two players are balanced, and the communication can be appropriately evaluated.

(7) In the entertainment system of (5) or (6), the at least one of the tone mark generating operation or the tone output operation is the tone mark generating operation.

(8) In the entertainment system according to (6), the count regarding the first player may be a count of the at least one of operations performed by the first player in a period from a predetermined period of time before a current time, to the current time, and the count regarding the second player may be a count of the at least one of operations performed by the second player in a period from the predetermined period of time before a current time, to the current time. In this manner, the two players are motivated to actively generate tone marks throughout the game, and thus decrease in communication frequency can be prevented.

(9) In the entertainment system according to any one of (6) to (8), the evaluating unit may increase the communication points as the count of the tone output operation by the first player and the count of the tone output operation by the second player each increase. This enables counting the tone output operation as a communication success.

(10) In the entertainment system according to (6), the evaluating unit may include a balance evaluating unit and a point calculating unit, the balance evaluating unit may calculate a balance level based on the comparison result, and the point calculating unit may calculate the communication points based on the balance level, the count of the tone output operation by the first player, and the count of the tone output operation by the second player. In this manner, the communication points can be increased when the movements (operations) of the two players are balanced and the count of the tone output operation by the two players is large. This serves to appropriately evaluate the communication.

(11) In the entertainment system according to (10), the balance level calculated by the balance evaluating unit may be higher when a difference between the count of the at least one of the tone mark generating operation and the tone output operation by the first player and the count of the at least one of the tone mark generating operation and the tone output operation by the second player is smaller.

(12) In the entertainment system according to any one of (1) to (11), the first player area may include at least a first operation area and a second operation area, and the second player area may include at least a third operation area and a fourth operation area. The first display control unit may generate a first tone mark in response to the tone mark generating operation on the first operation area and generate a second tone mark in response to the tone mark generating operation on the second operation area, and the second display control unit may generate a third tone mark in response to the tone mark generating operation on the third operation area and generate a fourth tone mark in response to the tone mark generating operation on the fourth operation area. This allows each player area to include a plurality of operation areas, thereby increasing the amount of communication between the two players.

(13) In the entertainment system according to any one of (1) to (12), the first player area may include at least a first operation area and a second operation area, and the second player area may include at least a third operation area and a fourth operation area. The first display control unit may generate a first tone mark in response to the tone mark generating operation on the first operation area, move the first tone mark toward the third operation area of the second player area, generate a second tone mark in response to the tone mark generating operation on the second operation area, and move the second tone mark toward the fourth operation area of the second player area. In this manner, a movement route of the tone mark from the first player area to the second player area is limited, and thus the movement of the tone mark is simplified and the tone output operation required for the second player can be facilitated.

(14) In the entertainment system according to (13), the second display control unit may generate a third tone mark in response to the tone mark generating operation on the third operation area, move the third tone mark toward the first operation area of the first player area, generate a fourth tone mark in response to the tone mark generating operation on the fourth operation area, and move the fourth tone mark toward the second operation area of the first player area. In this manner, a movement route of the tone mark from the second player area to the first player area is limited, and thus the movement of the tone mark is simplified and the tone output operation required for the first player can be facilitated.

(15) In the entertainment system according to any one of (1) to (14), the first display control unit may move the tone mark along a first lane from the first player area to the second player area, the second display control unit may move the tone mark along a second lane from the second player area to the first player area, and the first lane and the second lane may be defined so as to be opposed to each other across a center line of the display screen. In this manner, the tone mark from the first player area to the second player area is not mixed with the tone mark from the second player area to the first player area. This enables the two players to easily recognize the tone mark approaching their player areas.

(16) A program proposed in the present disclosure causes a computer to function as first display control means for generating a tone mark on a display screen in response to a tone mark generating operation by a first player and moving the tone mark toward a second player area provided on the display screen, second display control unit for generating a tone mark on a display screen in response to a tone mark generating operation by a second player and moving the tone mark toward a first player area provided on the display screen, first determining means for determining whether the first player performs a tone output operation at a time when the tone mark generated by the second player arrives at the first player area, second determining unit for determining whether the second player performs a tone output operation at a time when the tone mark generated by the first player arrives at the second player area, and evaluating means for calculating an amount of communication points based on at least one of the tone mark generating operation or the tone output operation by the first player and at least one of the tone mark generating operation or the tone output operation by the second player.

(17) A method for controlling an entertainment system proposed in the present disclosure includes the steps of generating a tone mark on a display screen in response to a tone mark generating operation by a first player and moving the tone mark toward a second player area provided on the display screen, generating a tone mark on a display screen in response to a tone mark generating operation by a second player and moving the tone mark toward a first player area provided on the display screen, determining whether the first player performs a tone output operation at a time when the tone mark generated by the second player arrives at the first player area, determining whether the second player performs a tone output operation at a time when the tone mark generated by the first player arrives at the second player area, and calculating an amount of communication points based on at least one of the tone mark generating operation or the tone output operation by the first player and at least one of the tone mark generating operation or the tone output operation by the second player.

### BRIEF DESCRIPTION OF THE DRAWINGS

FIG. 1A is a diagram illustrating an example of a display screen of an entertainment system proposed in the present disclosure;

FIG. 1B is a diagram illustrating an example of an operation of a player in the display screen;

FIG. 1C is a diagram illustrating an example of movement of an elongated tone mark in the display screen;

FIG. 2 is a block diagram showing hardware of the entertainment system;

FIG. 3 is a block diagram showing functions of a control unit of the entertainment system;

FIG. 4 is a diagram illustrating movement of a tone mark;

FIG. 5 is a diagram illustrating an example of a management table of the tone mark;

FIG. 6A is a flow chart showing processing of displaying the tone mark;

FIG. 6B is a diagram illustrating an example of the display screen for describing the processing shown in FIG. 6A;

FIG. 7 is a diagram showing evaluation of accuracy of timing of tone output operation;

FIG. 8 is a diagram showing an example of a change in a balance level;

FIG. 9 is a flow chart showing processing of calculating the balance level;

FIG. 10 is a diagram showing an example of a table (point table) to be used for calculating a communication point;

FIG. 11 is a flow chart showing an example of processing for calculating the communication point;

FIG. 12 is a diagram showing an example of audio data stored in a storage unit;

FIG. 13A is a flow chart showing an example of processing of a communication quantity expressing unit;

FIG. 13B is a diagram showing an example of changes in tracks;

FIG. 14A is a flow chart showing processing of displaying an elongated tone mark;

FIG. 14B is a diagram illustrating an example of the display screen for describing the processing shown in FIG. 14A;

FIG. 15 is a flow chart showing an example of processing for calculating the communication point;

FIG. 16 is a diagram showing another example of the display screen; and

FIG. 17 is a diagram showing yet another example of the display screen.

### DETAILED DESCRIPTION OF THE INVENTION

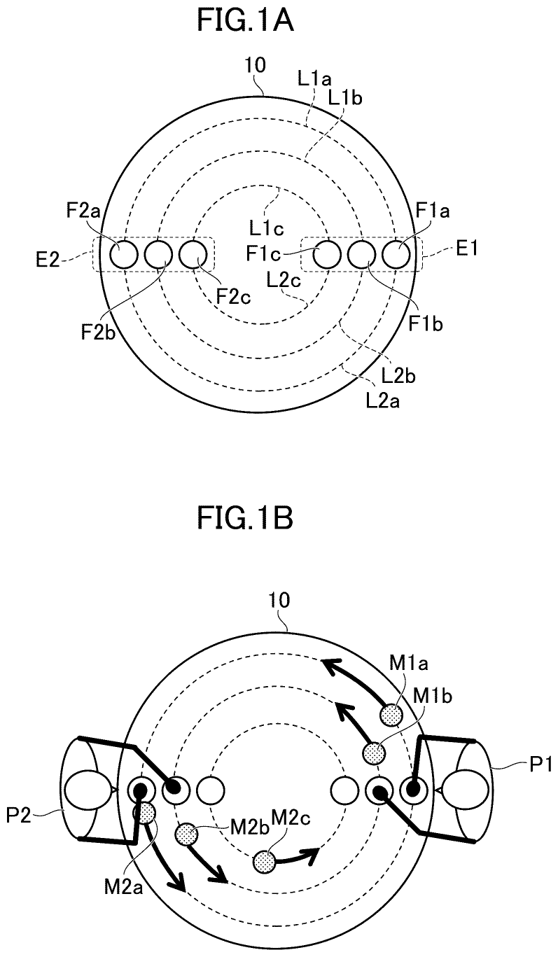

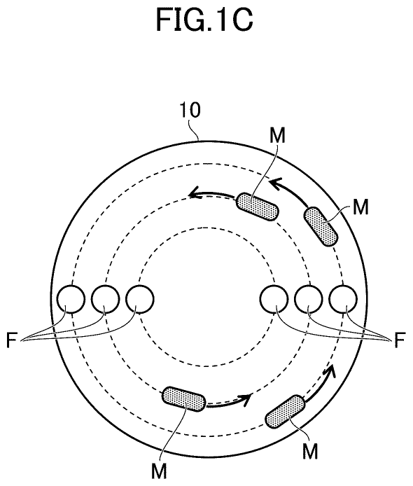

In the following, an entertainment system, a control method, and a program proposed in the present embodiment will be described. FIGS. 1A and 1B are diagrams illustrating a display screen 10, which is an example of a display screen included in the entertainment system.

### [Items Displayed on Display Screen]

An entertainment system 100 includes the display screen 10. The display screen 10 is constituted by a display device disposed as a top plate of a table, for example. As shown in FIG. 1A, the display screen 10 includes a first player area E1 provided for a first player P1 and a second player area E2 provided for a second player P2. The display screen 10 may include a touch sensor. The first player area E1 is for detecting a touch operation of the first player P1 using the touch sensor. The second player area E2 is for detecting a touch operation of the second player P2 using the touch sensor.

As shown in FIG. 1A, the display screen 10 may be circular, for example. The two player areas E1 and E2 may be provided opposite to each other across the center of the display screen 10, for example. Alternatively, the display screen 10 may have a quadrangular shape. In this case, the two player areas E1 and E2 may be provided on opposite sides of the center line of the display screen 10.

### [Generation of Tone Mark]

As shown in FIGS. 1A and 1B, the players P1 and P2 perform a touch operation (tone mark generating operation), for example, on the respective player areas E1 and E2, thereby generating tone marks M1a, M1b, etc. on the display screen 10. The first player area E1 may include a plurality of operation areas F1a to F1c (three areas in the example shown in FIG. 1A). The second player area E2 may also include the same number of operation areas F2a to F2c (three areas in the example shown in FIG. 1A). Each of the operation areas F1a to F1c and F2a to F2c receives a touch operation of the players P1 and P2. In response to the touch operation, tone marks M1a, M1b, M2a, M2b, etc. are generated.

The generated tone marks M1a, M1b, M2al, M2b, etc. move toward the player areas E1 and E2 of the opponent players. For example, as shown in FIG. 1B, the first player P1 touches the operation area F1a of the first player area E1, thereby generating the tone mark M1a. The tone mark M1a moves toward the operation area F2a of the second player area E2. In contrast, the second player P2 touches the operation area F2a of the second player area E2, thereby generating the tone mark M2a. The tone mark M2a moves toward the operation area F1a of the first player area E1.

This applies to all operation areas. That is, the tone marks generated in the operation areas F1a to F1c in the first player area E1 respectively move toward the operation areas F2a to F2c in the second player area E2, and the tone marks generated in the operation areas F2a to F2c in the second player area E2 respectively move toward the operation areas F1a to F1c in the first player area E1.

In the following, when the tone marks M1a, M1b, M2a, M2b, etc. are not distinguished from each other, a sign M is used for a tone mark. When the operation areas F1a to F1c and F2a to F2c are not distinguished, a sign F is used for an operation area.

The number of operation areas F provided in the respective player areas E1 and E2 is not limited to the example shown in FIG. 1A. The number of operation areas F may be more than three, or two or one.

The players P1 and P2 may continuously generate a plurality of tone marks M or may simultaneously generate a plurality of tone marks M. For example, the first player P1 intermittently touches the operation area F1a of the first player area E1, thereby generating a plurality of tone marks M1a arranged at intervals toward the operation area F2a of the second player area E2. The first player P1 simultaneously touches the operation areas F1a and Fib of the first player area E1, thereby generating two tone marks M1a and M1b respectively moving toward the operation areas F2a and F2b of the second player area E2.

### [Touch on Tone Mark (Tone Output Operation)]

The players P1 and P2 each perform a touch operation (tone output operation) on the respective player areas E1 and E2 in accordance with the time at which the tone mark M arrives at the player areas E1 and E2.

As described above, the tone mark M1a (see FIG. 1B) is generated in response to the touch operation on the operation area F1a of the first player area E1. The tone mark M1a moves toward the operation area F2a of the second player area E2. In this case, the second player P2 touches the operation area F2a in accordance with the time at which the tone mark M1a reaches the operation area F2a. The touch operation may be lightly tapping the surface of the display screen 10 (so-called tap operation), for example. In contrast, the tone mark M2a (see FIG. 1B) generated in response to the touch operation on the operation area F2a of the second player area E2 moves toward the operation area F1a of the first player area E1. In this case, the first player P1 touches the operation area F1a in accordance with the time at which the tone mark M2a reaches the operation area Fla.

The entertainment system 100 determines whether the timing of the players P1 and P2 to touch the operation area F matches the timing of the tone mark M to reach the operation area F. If the timings match, the entertainment system 100 adds a predetermined point to the previously accumulated points (in the following, such accumulated points are referred to as “communication points”). In this case, the entertainment system 100 may output a sound (sound effect) for notifying the players P1 and P2 of coincidence of timing via a speaker.

As described, in the entertainment system 100, the tone mark M generated by the first player P1 moves to the second player area E2, and the tone mark M generated by the second player P2 moves to the first player area E1. As such, for example, the second player P2 can feel the rhythm of the movement of the first player P1 (generation of the tone mark M), and the first player P1 can feel the rhythm of the movement of the second player P2 (generation of the tone mark M). This enables communication between the first player P1 and the second player P2 via the tone marks M, and the players P1 and P2 can obtain a sense of unity.

For coincidence of timing, a range of time or distance may be determined in advance. For example, when the players P1 and P2 touch the operation area F during a predetermined time period before and after the time when the position of the tone mark M coincides with the position (center) of the operation area F, the entertainment system 100 may determine that the timing coincides. Alternatively, when the players P1 and P2 touch the operation area F while the distance from the position (center) of the operation area F to the tone mark M is within the predetermined range, the entertainment system 100 may determine that the timing coincides.

The entertainment system 100 may control a background of a game based on the current communication point, for example. The background includes music that is output through a speaker and an image displayed on the display screen 10. Such processing of the entertainment system 100 will be described in detail later.

In the example described referring to FIG. 1B, the touch operation is lightly tapping the display screen 10. Alternatively, the players P1 and P2 may continue to touch the player areas E1 and E2 (more specifically, operation areas) for any period of time. In this case, as shown in FIG. 1C, a tone mark M having a length corresponding to the duration of the touch operation may be generated. In FIG. 1C, tone marks M are elongated in the moving direction. The display of the tone mark M starts when the touch operation starts. The tone mark M may be elongated in the moving direction until the touch operation ends.

On the screen 10, round tone marks M shown in FIG. 1B and elongated tone marks M shown in FIG. 1C may be displayed.

When the elongated tone marks M shown in FIG. 1C arrive at the player areas E1 and E2, the players P1 and P2 may continue the touch operation for a period corresponding to the length of the tone marks M. For example, when the front end of the tone mark M reaches the first player area E1 (specifically, operation area F), the first player P1 may start the touch operation. The first player P1 may continue the touch operation thereafter and terminate the touch operation when the rear end of the tone mark M passes through the first player area E1. In this case as well, the entertainment system 100 may output a sound (sound effect) for notifying of the continuation of the touch operation via the speaker.

The length of the tone mark M is freely determined. For example, the tone mark M may have a length obtained in such a manner that a period of the tone mark generating operation of one player P1 (or P2) partially overlaps a period of the tone output operation of the other player P2 (or P1). That is, the tone mark M having the length obtained in such a manner that, at the time when one player P1 (or P2) finishes the tone mark generating operation, the other player P2 (or P1) has already started the tone output operation, may be generated. In this manner, the movements of the two players P1 and P2 temporally overlap, and thus the players P1 and P2 can more effectively experience the communication.

[Lane in which Tone Mark Moves]

The display screen 10 previously defines a lane in which the tone mark M moves. This allows the players P1 and P2 to easily estimate the arrival of the tone marks M at the player areas E1 and E2. As such, the players P1 and P2 can easily touch the player areas E1 and E2 in accordance with the arrival of the tone marks M. This facilitates the communication between the two players P1 and P2 via the tone marks M.

As shown in FIG. 1A, a lane L1a may be defined from the operation area F1a of the first player area E1 to the operation area F2a of the second player area E2. Further, a lane L2a may be defined from the operation area F2a of the second player area E2 to the operation area F1a of the first player area E1. Lanes L1b, L1c, L2b, and L2c may be defined from the other operation areas F1b, F1c, F2b, and F2c to the corresponding operation areas (e.g., operation area Fib of first player area E1 and operation area F2b of second player area E2). In the following, when the lanes L1a, L1b, L1c, L2a, L2b, and L2c are not distinguished, a sign L is used for a lane. As shown in FIG. 1A, each lane L may be a substantially semicircular arc.

As shown in FIG. 1A, the operation areas F may be arranged in the radial direction of the circle. The lanes L1a to L1c from the first player area E1 to the second player area E2 and the lanes L2a to L2c from the second player area E2 to the first player area E1 are disposed opposite to each other across the center line passing through the operation areas F1a to F1c.

Such arrangement of the lanes L1a to L1c and L2a to L2c enables the players P1 and P2 to recognize the movement of the tone marks M, because the tone marks M from the first player area E1 to the second player area E2 are not mixed with the tone marks M from the second player area E2 to the first player area E1. As such, the players P1 and P2 can easily touch the operation area F in accordance with the arrival timing of the tone marks M and easily communicate with each other via the tone marks M.

### [Operation Area in Player Area]

In the example shown in FIG. 1A, for example, the operation area F to receive the touch operation for generating a tone mark M is the same as the operation area F to be touched by the players P1 and P2 at the time when the tone mark M arrives at the player areas P1 and P2. As such, if a touch operation is performed on the operation area F at the time when the tone mark M arrives, a communication point is added, and if a touch operation is performed on the operation area F other than the time at which the tone mark M arrives, a tone mark M is generated.

With such a function of the operation area F, the players P1 and P2 release their hands from the player areas E1 and E2 when the tone mark M has not arrived at the player areas E1 and E2 and they have no intention to generate a tone mark M. As such, the players P1 and P2 alternately repeat the operation of touching the operation area F and the operation of releasing the hands from the player areas E1 and E2. This generates a rhythm in the movement of the players P1 and P2, and the players P1 and P2 can feel the rhythm of the opponent via the tone marks M. Further, the number of tone marks M generated per unit time is also limited, which facilitates the operation (tone output operation) required for the players P1 and P2.

Unlike the example shown in FIG. 1A, for example, the operation area F to receive the touch operation for generating a tone mark M may be separately provided from the operation area F to be touched by the players P1 and P2 at the time when the tone mark M arrives at the player areas P1 and P2. That is, each of the player areas E1 and E2 may separately include an operation area to receive a touch operation for generating a tone mark M and an operation area to be touched by the players P1 and P2 at the time when the tone mark M arrives at the player areas P1 and P2.

### [Hardware]

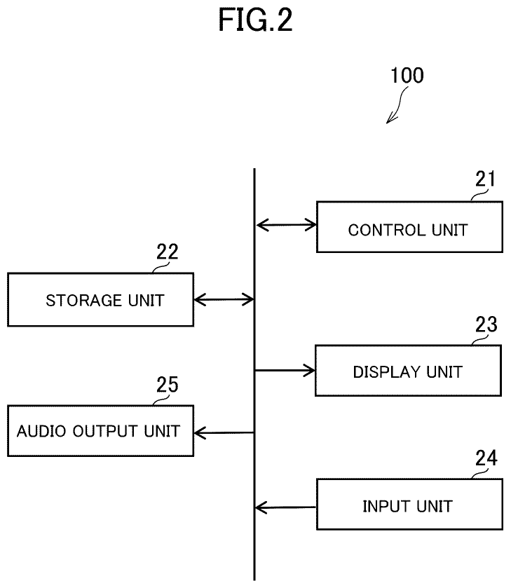

FIG. 2 is a block diagram showing hardware of the entertainment system 100. The entertainment system 100 includes a control unit 21, a storage unit 22, a display unit 23, an input unit 24, and an audio output unit 25. These units may be connected to one another via a bus or a network. The display unit 23 and the input unit 24 constitute the displaying screen 10 shown in FIG. 1A, for example.

The control unit 21 includes a CPU (central processing unit), a GPU (graphics processing unit), and an SPU (sound processing unit), for example. The control unit 21 executes various processes according to the operating system or other programs.

The storage unit 22 includes a RAM (random access memory), a ROM (read only memory), an SSD (solid state drive), and an HDD (hard disc drive), for example. The storage unit 22 stores programs and data. The storage unit 22 is also used as working memory for storing data required in the processing performed by the control unit 21.

The display unit 23 includes a display device and displays a screen according to an instruction from the control unit 21. For example, a liquid crystal display device and an organic EL (electroluminescence) display device may be used as the display device.

The input unit 24 may be a touch sensor laminated on the display device constituting the display unit 23, for example. The input unit 24 inputs a signal corresponding to the operation of the players P1 and P2 to the control unit 21. Various types of sensors, such as a resistive film type sensor and a capacitive type sensor, may be used as the touch sensor.

The audio output unit 25 includes a sound buffer and a speaker, for example. The audio output unit 25 outputs audio data (specifically, background music played during game), which is read from the storage unit 22 to the sound buffer, from the speaker according to the instruction of the control unit 21.

### [Modification of Hardware]

The hardware of the entertainment system 100 is not limited to the example shown in FIG. 2.

For example, the entertainment system 100 may include, as the input unit 24, one or more operating pedals for the players P1 and P2 to operate with the foot in place of, and/or in addition to the touch sensor provided on the display screen 10. In this case, when the players P1 and P2 step on the operating pedals, the entertainment system 100 may generate a tone mark M on the display screen 10. Further, the entertainment system 100 may determine whether the operating pedals are pressed in accordance with the time at which the tone mark M arrive at the player areas E1 and E2.

As yet another example, the entertainment system 100 may include one or more operating buttons as the input unit 24 in place of, and/or in addition to the touch sensor provided on the display screen 10. In this case, the entertainment system 100 may generate a tone mark M on the display screen 10 when the operating button is pressed by the players P1 and P2. Further, the entertainment system 100 may determine whether the operating button is pressed in accordance with the time at which the tone mark M arrive at the player areas E1 and E2.

As yet another example, the entertainment system 100 may include, as the input unit 24, an imaging device for detecting the movement of bodies of the players P1 and P2. In this case, the entertainment system 100 may generate a tone mark M on the display screen 10 when the players P1 and P2 make a predetermined gesture. Further, the entertainment system 100 may determine whether the players P1 and P2 have made a predetermined gesture in accordance with the time at which the tone mark M arrive at the player areas E1 and E2.

As yet another example, the entertainment system 100 may include, as the display unit 23, a display device that is installed on a wall or a display device that is installed so as to stand on a table top plate, instead of the display device that functions as a table top plate. In this case, a game controller manually operated by the players P1 and P2 may be used as the input unit 24.

### [Processing Executed by Control Unit]

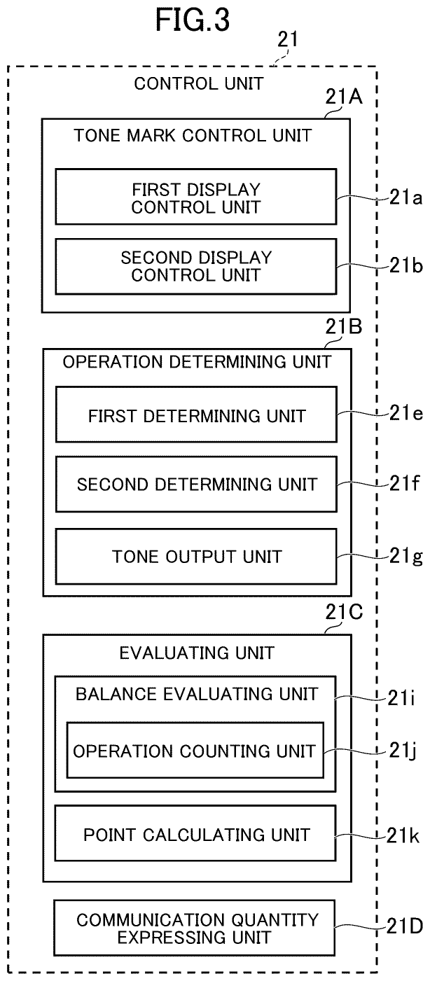

FIG. 3 is a block diagram showing functions of the entertainment system 100. The entertainment system 100 functionally includes a tone mark control unit 21A, an operation determining unit 21B, an evaluating unit 21C, and a communication quantity expressing unit 21D, for example. These functions are implemented when the control unit 21 executes the program stored in the storage unit 22.

### [Generation of Tone Mark by Tone Mark Control Unit]

As shown in FIG. 3, the tone mark control unit 21A includes a first display control unit 21a and a second display control unit 21b.

The first display control unit 21a generates a tone mark M in response to the tone mark generating operation performed by the first player P1, and displays the tone mark M on the display screen 10. The second display control unit 21b generates a tone mark M in response to the tone mark generating operation performed by the second player P2, and displays the tone mark M on the display screen 10.

As described referring to FIG. 1B, the tone mark generating operation is a touch operation on the player areas E1 and E2, for example. More specifically, the tone mark generating operation by the first player P1 is a touch operation on the operation areas F1a to F1c, and the tone mark generating operation by the second player P2 is a touch operation on the operation areas F2a to F2c. The touch operation may be lightly tapping the display screen 10, for example.

Upon detecting that a tone mark generating operation has been performed based on a signal entered from input unit 24, which is a touch sensor, the display control units 21a and 21b instantaneously start displaying the tone mark M. The position of the tone mark M at the beginning of display may be the player areas E1 and E2, for example. More specifically, when a touch operation is applied to the operation area F1a of the first player area E1, the tone mark M may be displayed in the operation area Fla, and when a touch operation is applied to the operation area F1b, the tone mark M may be displayed in the operation area Fib. The same may be applied when a touch operation is applied to other operation areas F1c and F2a to F2c.

The tone mark generating operation is not limited to lightly tapping the player areas E1 and E2 (so-called tapping operation). For example, the tone mark generating operation may be continuing to touch the operation area F for any period of time. In this case, as described referring to FIG. 1C, the display control units 21a and 21b may generate a tone mark M having a length corresponding to such a period of time and display the tone mark M on the display screen 10.

Examples of the tone mark generating operation may include various operations, such as an operation of strongly pressing the player areas E1 and E2 and an operation of sliding a hand in the player areas E1 and E2. A tone mark corresponding to a type of tone mark generating operation may be generated on the display screen. These tone marks may be different in sizes and sounds (sound effects) that are output when the tone marks are touched, for example.

As discussed above, the input unit 24 may include operating pedals. When the operating pedals are provided as the input unit 24, the tone mark generating operation is pressing the operating pedals, for example. The entertainment system 100 may include a plurality of operating pedals as the input unit 24. In this case, when the tone mark generating operation is performed on the first operating pedal, the display control units 21a and 21b may generate a tone mark M in the first operation area (e.g., operation area F1a or F2a) of the operation areas F included in the player areas E1 and E2. Similarly, when the tone mark generating operation is performed on the second operating pedal, the display control units 21a and 21b may generate a tone mark M in the second operation area (e.g., operation area Fib or F2b) of the operation areas F included in the player areas E1 and E2.

As described above, the input unit 24 may include an operating button. The entertainment system 100 may include a plurality of operating buttons as the input unit 24. In this case, when the tone mark generating operation is performed on the first operating button, the display control units 21a and 21b may generate a tone mark M in the first operation area (e.g., operation area F1a or F2a) of the operation areas F included in the player areas E1 and E2. Similarly, when the tone mark generating operation is performed on the second operating button, the display control units 21a and 21b may generate a tone mark M in the second operation area (e.g., operation area Fib or F2b) of the operation areas F included in the player areas E1 and E2.

As described above, the input unit 24 may include an imaging device. In this case, the tone mark generating operation may be a predetermined gesture. In this case, some gestures may be defined as gestures recognized as the tone mark generating operation. When the first gesture (e.g., raising the right arm) defined as the tone mark generating operation is performed, the display control units 21a and 21b may generate a tone mark M in the first operation area (e.g., operation area F1a or F2a) among the operation areas included in the player areas E1 and E2. Similarly, when the second gesture (e.g., raising the left arm) defined as the tone mark generating operation is performed, the display control units 21a and 21b may generate a tone mark M in the second operation area (e.g., operation area Fib or F2b) among the operation areas included in the player areas E1 and E2.

### [Movement of Tone Mark by Tone Mark Control Unit]

The first display control unit 21a moves the tone mark M displayed in the first player area E1 toward the second player area E2. The second display control unit 21b moves the tone mark M displayed in the second player area E2 toward the first player area E1.

The display control units 21a and 21b may move the tone mark M along the lane L described above (see FIG. 1A). For example, the first display control unit 21a moves the tone mark M displayed in the operation area F1a toward the operation area F2a along the lane L1a. The second display control unit 21b moves the tone mark M displayed in the operation area F2a toward the operation area F1a along the lane L2a. The display control unit 21a and 21b also move the tone marks M displayed in the other operation areas F1b, F1c, F2b, and F2c in the same manner. The display control units 21a and 21b may move each tone mark M at a constant speed. For example, the display control units 21a and 21b may move a plurality of tone marks M1a moving along the lane L1a (see FIG. 1A) and a plurality of tone marks M2a moving along the lane L2a (see FIG. 1A) at the same speed. This may be the same for the tone marks M1b and M1c moving along the other lanes L1b and L1c and the tone marks M2b and M2c moving along the lanes L2b and L2c.

This allows the players P1 and P2 to easily touch the player areas E1 and E2 in accordance with the arrival of the tone mark M. In this manner, the communication between the two players P1 and P2 via the tone marks M can be facilitated.

The time required for the tone marks M1a, M1b, and M1c moving along the lanes L1a, L1b, and L1c to move from the first player area E1 to the second player area E2 may be the same. Similarly, the time required for the tone marks M2a, M2b, and M2c moving along the lanes L2a, L2b, and L2c to move from the second player area E2 to the first player area E1 may also be the same. In other words, the angular velocity of the tone marks M1a, M1b, M1c, M2a, M2b, and M2c may be the same.

This allows the players P1 and P2 to easily touch the player areas E1 and E2 in accordance with the arrival of the tone mark M. In this manner, the communication between the two players P1 and P2 via the tone marks M can be facilitated.

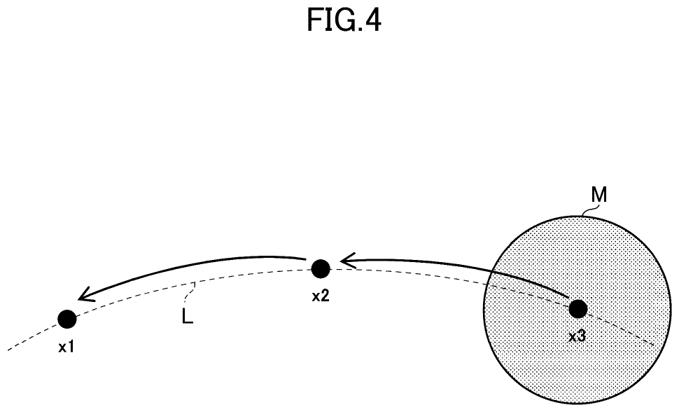

The entertainment system 100 may output music from the speaker. The moving speed of the tone mark M may be set according to the tempo of the music. As shown in FIG. 4, a plurality of guide points x1, x2, x3, etc., evenly spaced may be provided in each lane L. The guide points x1, x2, x3, etc. and the tone mark M may move along the lane L at the same speed. In this case, the moving speed of the guide points x1, x2, and x3 may be determined in accordance with the tempo of the music.

For example, the tempo of music output from the speaker may be 120 bpm (beat per minute) and the guide points x1, x2, x3, etc. may represent one-sixteenth of a beat. In this case, the tone mark M may move to the next guide point in 0.125 seconds. The beats indicated by the tempo of music and the guide points x1, x2, x3, etc. are not limited to these examples above, and may be changed as appropriate.

As will be described later, a balance level is determined in the entertainment system 100 to indicate the balance between the operation of the first player P1 and the operation of the second player P2. The moving speed of the tone mark M may be constant regardless of the balance level.

Unlike the example described above, the speed (angular velocity) of the tone mark M may be set according to the lane L or the balance level.

### [Management of Tone Mark]

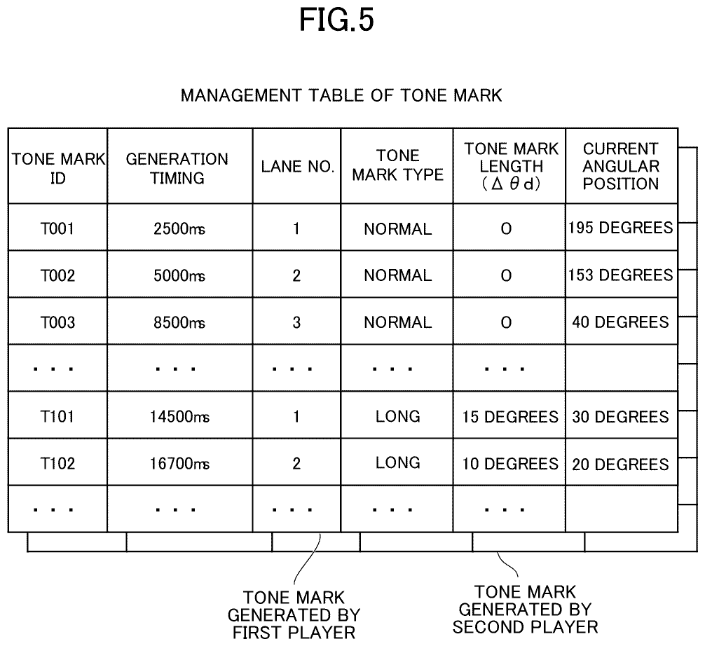

The tone mark control unit 21A manages the position and display of the generated tone mark. The tone mark control unit 21A may include a table for management (hereinafter, this table is referred to as a management table), for example. FIG. 5 is a diagram illustrating an example of such a management table. As shown in FIG. 5, a management table may be provided for each of the players P1 and P2, or one management table may be provided for the players P1 and P2.

When the tone mark generating operation is executed, the tone mark control unit 21A records the time (generation time) in the management table. Such record may be used in the processing of an operation counting unit 21j to be described later. The tone mark control unit 21A may record the generation time of the tone mark M in the management table in association with the tone mark ID.

The tone mark control unit 21A may record the number of the lane L in which the tone mark M is generated in the management table. Further, the tone mark control unit 21A may record the type of the tone mark M and the length of the tone mark M in the management table. The type of the tone mark M may include a round tone mark (normal) shown in FIG. 1B and an elongated tone mark (long) shown in FIG. 1C, for example. The length of the tone mark may be an angular range between a front end and a rear end of the elongated tone mark.

A current position of each tone mark may be recorded in the management table. In the example shown in FIG. 1A, the tone mark M moves along the arc-shaped lane L. As such, the current angular position θp of the tone mark M may be recorded in the management table. The display control units 21a and 21b may update the angular position θp at a predetermined cycle (e.g., cycle corresponding to the frame rate of the display screen 10).

### [Display Processing of Tone Mark]

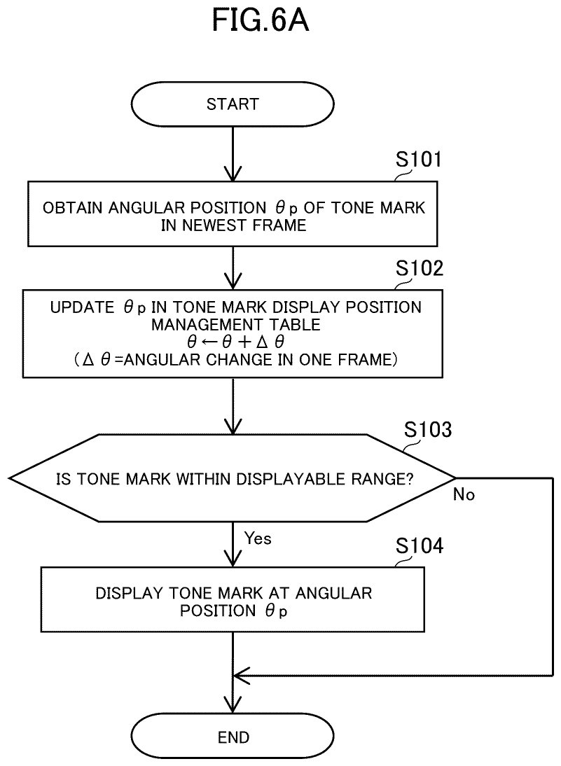

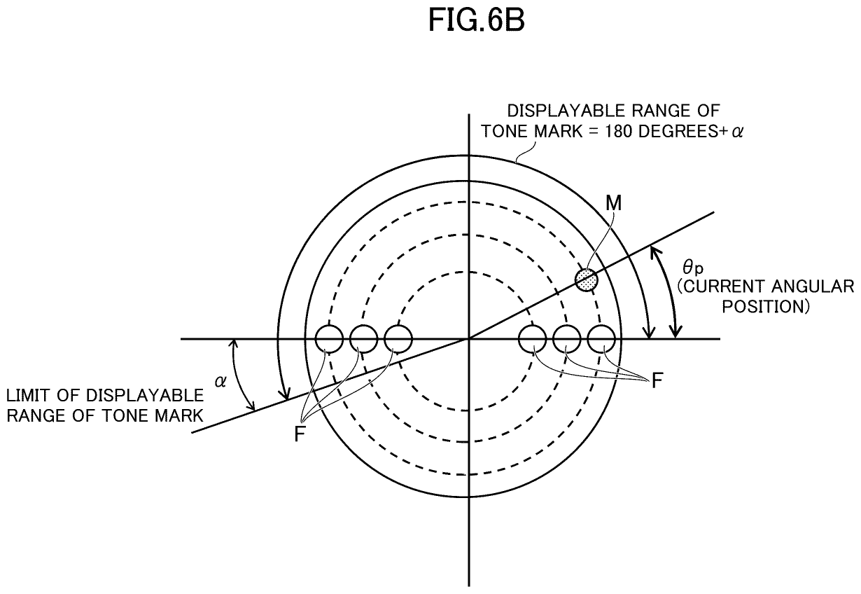

FIG. 6A is a flow chart showing the processing performed by the display control units 21a and 21b of the tone mark control unit 21A for each tone mark M. FIG. 6B is a diagram for explaining such processing.

A current position of each tone mark M is recorded in the management table of the tone mark M (see FIG. 5). In the example shown in FIG. 1A, the tone mark M moves along the arc-shaped lane L. As such, a current angular position θp (see FIG. 6B) of each tone mark M may be recorded in the management table. The display control units 21a and 21b update the angular position Op of each tone mark M at a predetermined cycle (cycle corresponding to the frame rate of the display screen 10).

Specifically, as shown in FIG. 6A, the display control units 21a and 21b refers to the management table of the tone marks and obtains the angular position θp of the tone mark M in the most recent frame (S101). The display control units 21a and 21b then add a predetermined angle (Δθ: an angle at which the tone mark M advances in one frame) to the angular position θp, and records the result of addition (θ+Δθ) as a new angular position θp in the management table (S102).

The display control units 21a and 21b then determines whether the tone mark M is within a displayable range based on the updated angular position θp (S103). In a case where the position in the player areas E1 and E2 in which the tone mark M is generated is set to 0 degrees, the displayable range may be “0 degrees to 180 degrees+α”, for example. As shown in FIG. 6B, the displayable range (0 to 180 degrees+α) is a range from the player area E1 (or E2) to the position of the opponent player past the player area E2 (or E1), for example. That is, the tone mark M generated in the first player area E1 may be displayed up to a position past the second player area E2. In contrast, the tone mark M generated in the second player area E2 may be displayed to a position past the first player area E1.

If the tone mark M is within the displayable range (“yes” in S103), the display control units 21a and 21b display the tone mark M at the angular position θp (S104). For example, the tone mark M moving in the lane L1a from the first player area E1 toward the second player area E2 is displayed at the angular position θp in the lane L1a. On the contrary, the tone mark M moving in the lane L2a from the second player area E2 toward the first player area E1 is displayed at the angular position θp in the lane L2a.

If the tone mark M is not within the displayable range (“no” in S103), the display control units 21a and 21b terminate the processing for the current frame without displaying the tone mark M on the display screen 10. If the tone mark M is not within the displayable range, the display control units 21a and 21b may remove the record for this tone mark M from the management table.

The display control units 21a and 21b may perform the processing shown in FIG. 6A in each frame for each of the tone marks.

### [Operation Determining Unit]

The operation determining unit 21B may include a first determining unit 21e, a second determining unit 21f, and a tone output unit 21g.

When the tone mark M generated by the second player P2 arrives at the first player area E1, the first determining unit 21e determines whether the tone output operation has been performed by the first player P1. When the tone mark M generated by the first player P1 arrives at the second player area E2, the second determining unit 21f determines whether the tone output operation has been performed by the second player P2.

The tone output operation is a touch operation on the player areas E1 and E2, for example. As shown in FIG. 1A, for example, if the player areas E1 and E2 each include a plurality of operation areas F, the tone output operation is a touch operation on each operation area F. The touch operation may be lightly tapping the operation area F (so-called tap operation), for example.

As described referring to FIG. 1C, the touch operation regarding the elongated tone mark M may be continuing to touch the player area E while the tone mark M passes through the player area E.

### [Accuracy of Timing of Tone Output Operation]

The determining units 21e and 21f may evaluate an accuracy of timing of performing the tone output operation. A point calculating unit 21k, which will be described later, may add a point according to the accuracy. The accuracy of timing is a temporal or distant proximity between the timing of coincidence of the center of the tone mark M with the center of the operation area F and the timing of the tone output operation.

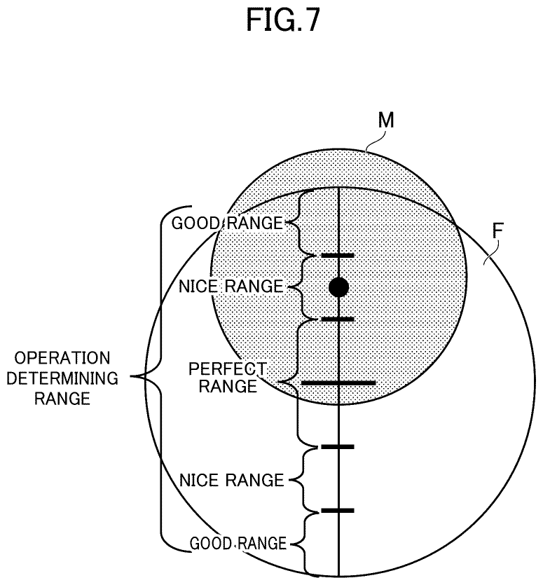

FIG. 7 is a diagram illustrating such processing of the determining units 21e and 21f. A plurality of ranges having different evaluations (points to be added) may be set in the operation areas F of the player areas E1 and E2. For example, as shown in FIG. 7, three types of ranges (Perfect range N1, Nice range N2, Good range N3) may be set. These three ranges may be set based on a distance from the center of the operation area F or a temporal difference from the time at which the center of the tone mark M coincides with the center of the operation area F.

The Perfect range N1 (first range) is closest to the center C of the operation area F in the extending direction of the lane L. The Nice range N2 (second range) may be adjacent to the Perfect range in the moving direction of the tone mark M. The Good range N3 (third range) may be adjacent to the Nice range in the moving direction of the tone mark M.

As shown in FIG. 7, two Nice ranges N2 positioned opposite to each other across the Perfect range N1 may be provided in the player areas E1 and E2. Further, two Good ranges N3 positioned opposite to each other across the Perfect range N1 and the Nice range N2 may be provided in the player areas E1 and E2. In a case where three such types of ranges N1, N2, and N3 are provided, points corresponding to the ranges may be added to the communication points in the processing of the point calculating unit 21k to be described later.

### [Tone Output Unit]

When the tone output is operated at the time when the tone mark M arrives at the player areas E1 and E2, the tone output unit 21g may output a sound (sound effect) via the audio output unit 25 (see FIG. 2) including the speaker.

At this time, the tone output unit 21g may adjust the volume and the tone of the sound according to the music data output from the communication quantity expressing unit 21D to be described later. For example, the tone output unit 21g may adjust the volume or the tone of the sound based on the type of music output from the communication quantity expressing unit 21D, for example.

As another example, the tone output unit 21g may adjust the volume or the quality of the sound based on the evaluation of the tone output operation (accuracy of the timing of the tone output operation). For example, when the tone output operation is performed when the tone mark M is in the Perfect range N1, the volume of the sound may be increased more compared to the case where the tone output operation is performed when the tone mark M is in another range.

As described above, the input unit 24 may include an operating pedal and an operating button, for example. In this case, the tone output operation may be pressing the operating pedal (or operating button), for example. That is, the determining units 21e and 21f may determine whether the operating pedal is pressed at the time when the tone mark M arrives at the operation area F (or whether the operating button is pressed).

As described above, the input unit 24 may include an imaging device. In this case, the tone output operation may be a predetermined gesture, for example. That is, the determining units 21e and 21f may determine whether the predetermined gesture has been made at the time when the tone mark M arrives at the operation area F. Such a gesture may be the same as the gesture performed as the tone mark generating operation.

### [Evaluating Unit]

The evaluating unit 21C calculates a communication point based on the tone mark generating operation and the tone output operation performed by the first player P1 and the tone mark generating operation and the tone output operation performed by the second player P2. For example, if the count of tone output operations performed in accordance with the arrival timing of the tone mark M is large, it can be determined that the intention of one player has been transmitted more to the other player. In this case, a high communication point may be provided.

For example, the evaluating unit 21C may compare the operation performed by the first player P1 and the operation performed by the second player P2, and calculate a communication point based on the comparison result. The operation of the players P1 and P2 may be at least one of the tone mark generating operation and the tone output operation.

For example, the evaluating unit 21C may calculate the communication point based on a difference or a ratio between a value corresponding to the count of operations performed by the first player P1 (including the count itself) and a value corresponding to the count of operations performed by the second player P2 (including the count itself). When the difference between the operation of the first player P1 and the operation of the second player P2 is small, a relatively high point may be added.

The calculating method of the communication point described above can increase the communication points when the movements of the two players P1 and P2 are balanced, that is, when the roles of the two players P1 and P2 (generating of the tone mark M and the touch operation) are alternated in a well-balanced manner.

As shown in FIG. 3, the evaluating unit 21C may include a balance evaluating unit 21i and a point calculating unit 21k. The balance evaluating unit 21i may include the operation counting unit 21j.

### [Balance Evaluating Unit]

The balance evaluating unit 21i may calculate a balance level based on a comparison between the tone mark generating operation performed by the first player P1 and the tone mark generating operation performed by the second player P2. For example, the balance evaluating unit 21i may calculate the balance level based on a difference between the count of tone mark generating operations performed by the first player P1 and the count of tone mark generating operations performed by the second player P2. When the difference in the counts is smaller, the balance level may be evaluated higher.

The balance evaluating unit 21i may calculate the balance level based on the count of tone mark generating operations in a period of time from a predetermined period of time before the current time, to the current time (e.g., several tens of seconds before). The period from a predetermined period of time before the current time, to the current time, is hereinafter referred to as an “operation counting period”. For example, the balance evaluating unit 21i may calculate the balance level by using the following mathematical formula 1.

$$K = \frac{\vert A - B \vert}{A + B} \qquad Mathematical formula 1$$

A: the count of tone mark generating operations performed by the first player P1 during the operation counting period. In the following, the count A is referred to as the “first player operation count.”
B: the count of tone mark generating operations performed by the second player P2 during the operation counting period. In the following, the number of times B is referred to as the “second player operation count”.
K: balance evaluation value

### [Conditions of Balance Level]

When such a balance evaluation value K is calculated, the balance evaluating unit 21i may calculate (set) the balance level by using the balance evaluation value K. When the balance evaluation value K is smaller, the balance of the players P1 and P2 may be evaluated better. The balance level may be calculated using the following conditional expression, for example:

0<K≤T1:fourth balance level(uppermost level) Condition 1

T2≤K<T3:third balance level Condition 2

T3≤K<T4:second balance level Condition 3

T4≤K<1:first balance level(lowest level) Condition 4

where 0≤T2<T1, T2<T3<T4.

According to the conditional expressions above, for example, when the difference between the first player operation count A and the second player operation count B (A-B) is smaller, the balance level is closer to the uppermost level (the fourth balance level).

In the example described above, the four balance levels are defined, but the number of the balance levels is not limited to this and may be less than four or more than four.

Further, the balance evaluating unit 21i may calculate the balance level based on the sum of the first player operation count A and the second player operation count B (A+B). When the sum (A+B) is greater, the balance level may be higher. For example, the condition for the uppermost balance level (fourth balance level) may be the sum A+B being greater than a threshold value.

Such a calculation method of the balance level allows a higher balance level to be established in a situation where the two players P1 and P2 generate a large number of tone marks M while changing their roles (generating of tone marks M) in a good balance.

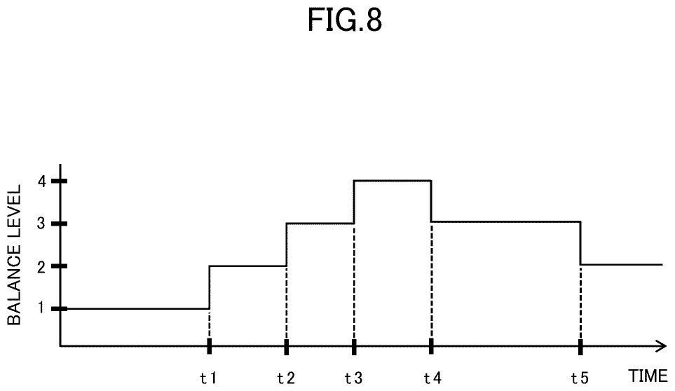

The player operation count (A, B) is the count of tone mark generating operations performed in the operation counting period (i.e., a period of time from a predetermined period of time before the current time, to the current time). As such, the balance level is moved up and down during the game. FIG. 8 is a diagram illustrating such a change in the balance level.

In the example shown in FIG. 8, a first balance level is maintained from the start of the game to the time t1. The balance level is gradually increased at the time points t1, t2, and t3. However, the player operation counts (A, B) become unbalanced thereafter, and consequently, the balance level gradually decreases at the time points t4 and t5. Such processing of the balance evaluating unit 21i urges the players P1 and P2 to actively generate tone marks M at all times in order to maintain the balance of the operation. This facilitates communication between the player P1 and the player P2.

### [Modification of Calculation of Balance Level]

The calculation method of the balance level is not limited to the example described above.

For example, the balance evaluating unit 21i may calculate the balance level based on the ratio (A/B) of the player operation counts, rather than the difference (A-B) between the player operation counts. In this case, as the ratio approaches 1, the balance level may approach the uppermost level.

In the example described above, the player operation counts A and B are the counts of tone mark generating operations. However, the comparison of the tone output operations of the player P1 and the player P2 (difference or ratio of the count of operations) may be used to calculate the balance level in addition to using the count of tone mark generating operations or in place of using the count of tone mark generating operations. For example, the player operation counts (A, B) in the “mathematical formula 1” described above may be respectively the counts of tone output operations performed by the players P1 and P2 during the operation counting period. Further, the accuracy of the timing of the tone output operation may also be considered in calculating the balance level.

The difference or ratio used to calculate the balance level may be a difference or a ratio of numerical values calculated based on the player operation count, rather than a difference (A-B) or a ratio (A/B) of the player operation count. For example, when the elongated tone mark M (previously described) referring to FIG. 1C is generated, a balance evaluation value K may be calculated by using a value obtained by multiplying the count of generations by a coefficient k (count of generations×k).

As described above, each of the player areas E1 and E2 has a plurality of operation areas (Fla to F1c, F2a to F2c, see FIG. 1A). The balance evaluation value may be calculated for each of the pairs of the operation areas.

For example, the balance evaluating unit 21i may calculate three balance evaluation values Ka, Kb, and Kc. The balance evaluation value Ka may be calculated based on the count of tone mark generating operations performed on the pair of operation areas F1a and F2a, for example. Similarly, the balance evaluation value Kb may be calculated based on the count of tone mark generating operations performed on the pair of operation areas Fib and F2b, and the balance evaluation value Kc may be calculated based on the count of tone mark generating operations performed on the pair of operation areas F1c and F2c. The balance level may be calculated based on the three balance evaluation values Ka to Kc.

### [Operation Counting Unit]

The operation counting unit 21j counts the operations of the players P1 and P2. In the example described above, the balance evaluation value K is calculated by using the count (A, B) of the tone mark generating operations performed in the operation counting period (a period of time from a predetermined period of time before the current time, to the current time, such as several tens of seconds). As such, the operation counting unit 21j counts the operations performed during the operation counting period (i.e., the number of generated tone marks M).

For example, the operation counting unit 21j may use the management table shown in FIG. 5 so as to execute the counting. As described above, when the tone mark generating operation is executed, the tone mark control unit 21A records the time (generation timing) in the management table. The operation counting unit 21j may refer to the management table and count the tone mark generating operations performed during the operation counting period.

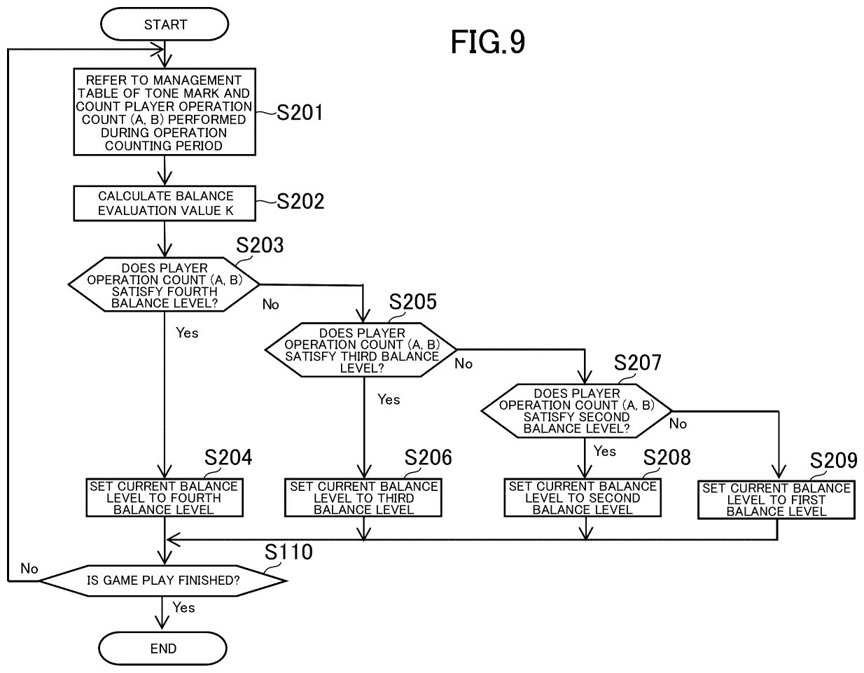

FIG. 9 is a flow chart showing an example of the processing executed by the balance evaluating unit 21i.

As shown in FIG. 9, the operation counting unit 21j refers to the management table of the tone marks (FIG. 5) and calculates the player operation counts (A, B) performed by the first and second players P1 and P2 during the operation counting period (S201). The balance evaluating unit 21i calculates the balance evaluation value K described above based on the calculated player operation counts (A, B) (S202).

The balance evaluating unit 21i determines whether the first player operation count A and the second player operation count B satisfy the fourth balance level (S203). For example, the balance evaluating unit 21i determines whether the balance evaluation value K satisfies “condition 1” described above and whether the sum (A+B) of the player operation counts is larger than the threshold value V (A+B>V). If the player operation counts (A, B) satisfy the condition of the fourth balance level (“yes” in S203), the balance evaluating unit 21i sets the current balance level to the fourth balance level (S204).

On the other hand, if the player operation counts (A, B) does not satisfy the condition of the fourth balance level (“no” in S203), it is determined whether the player operation counts A and B satisfy the condition of the third balance level (S205). For example, the balance evaluating unit 21i determines whether the balance evaluation value K satisfies “condition 2” described above. If the player operation counts (A, B) satisfy the third balance level (“yes” in S205), the balance evaluating unit 21i sets the current balance level to the third balance level (S206).

On the other hand, if the player operation counts (A, B) does not satisfy the condition of the third balance level (“no” in S205), the balance evaluating unit 21i determines whether the player operation counts A and B satisfy the condition of the second balance level (S207). For example, the balance evaluating unit 21i determines whether the balance evaluation value K satisfies “condition 3” described above. If the player operation counts (A, B) satisfy the second balance level (“yes” in S207), the balance evaluating unit 21i sets the current balance level to the second balance level (S208).

If the player operation counts (A, B) does not satisfy the condition of the second balance level (“no” in S207), the balance evaluating unit 21i sets the current balance level to the first balance level (S209).

The balance evaluating unit 21i sets the balance level in one of S204, S206, S208 and S209, and then determines whether the game is finished (S110). If the game is not finished (“no” in S110), the balance evaluating unit 21i returns to S201 and executes the subsequent processing again.

When the game is finished (“yes” in S110), the balance evaluating unit 21i terminates the processing. The game may be terminated when a predetermined period of time has elapsed since the start of the game, when communication points to be described later reach a predetermined value, or when a predetermined termination operation is performed by the players P1 and P2.

As shown in FIG. 5, the management table may record the number of the lane L in which the tone mark M is generated. The operation counting unit 21j may count the tone mark generating operations for each lane L. The balance level may then be calculated based on the count of operations for each lane.

In the example shown in FIG. 5, the types of tone marks are recorded. The operation counting unit 21j may count the number of tone marks M for each type. The result of such counting may be used to calculate the balance level.

### [Point Calculating Unit]

The point calculating unit 21k calculates a communication point based on the count of operations performed by the first player P1 and the count of operations performed by the second player P2. Specifically, the operations by the players P1 and P2 described here may be the tone output operation and/or tone mark generating operation described above.

The point calculating unit 21k may increase the communication point as the counts of the tone output operations performed by each of the players P1 and P2 increase. If the count of tone output operations is large, the communication between the two players via the tone mark M is good. As such, the communication point calculated in this manner can be regarded as the degree of good communication.

In this specification, the tone output operation is a touch operation performed by the players P1 and P2 in accordance with the arrival timing of the tone mark M. The touch operation that is not performed on the arrival timing is not counted as the tone output operation. The tone output operation may be a pedal operation, a button operation, and a gesture performed in accordance with the arrival timing of the tone mark M. In this case as well, an operation such as the pedal operation that is not performed on the arrival timing is not counted as a tone output operation.

The point calculating unit 21k may calculate a communication point based on the balance level described above. For example, the calculation processing of the point calculating unit 21k may be executed such that the higher communication point is obtained when the balance level is higher. More specifically, when the balance level is higher, the higher point may be added for each tone output operation.

The point calculating unit 21k may calculate a communication point based on the accuracy of the timing of performing the tone output operation. The accuracy of timing is a temporal or distant proximity between the timing of coincidence of the center of the tone mark M with the center of the operation area F and the timing of the tone output operation. The calculation processing of the point calculating unit 21k may be executed so that a higher communication point is obtained when a temporal or distant proximity between them is smaller.

For example, as shown in FIG. 7, the ranges (Perfect range N1, Nice range N2, Good range N3) may be set in accordance with the distance from the center C of the operation area F. In this case, the point calculating unit 21k may calculate a communication point based on the position of the tone mark M at the time when the tone output is performed.

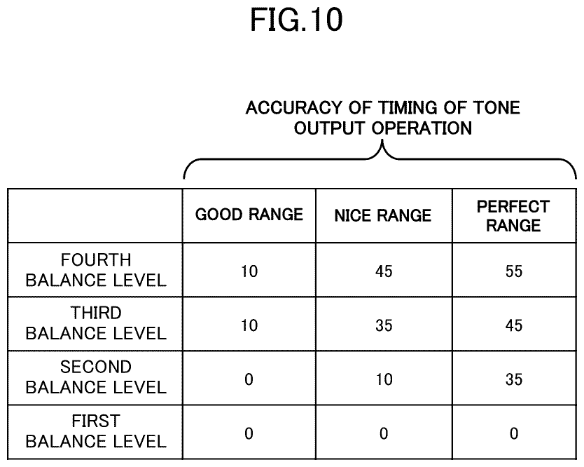

FIG. 10 is an example of a table to be used for calculating a communication point (the table will be referred to as a “point table”). In the point table, points to be added for one tone output operation are defined in association with the balance level and the accuracy of the timing of performing the tone output operation.

For example, a higher point may be associated with a higher balance level in the point table. Further, a higher point may be set when the accuracy of the timing of performing the tone output operation is higher (is closer to the center of the operation area F) in this point table.

The point calculating unit 21k refers to the point table when the tone output operation is performed. The point calculating unit 21k adds a point corresponding to the current balance level and the accuracy of the tone output operation to the communication points obtained so far.

As shown in FIG. 10, 0 points may be set for the lowest level (first balance level) of the balance level. In other words, when only one of the two players P1 and P2 generates a large number of tone marks M, a point may not be added regardless of the count of tone output operations.

### [Processing for Point Calculation]

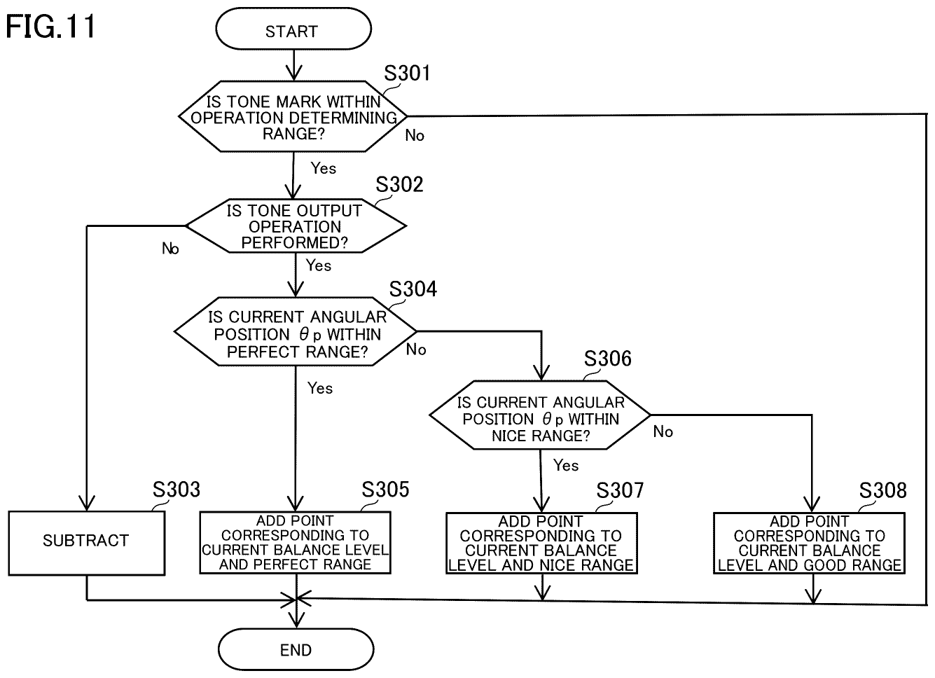

FIG. 11 is a flow chart showing an example of processing executed by the operation determining unit 21B and the evaluating unit 21C.

The determining units 21e and 21f refer to the tone mark management table (FIG. 5) and determine whether the tone mark M is within the operation determining range (S301). The operation determining range is a range in which whether a tone output operation is performed for the tone mark M is determined. The operation determining range is obtained by combining the Good range, the Nice range, and the Perfect range shown in FIG. 7, for example. The determining units 21e and 21f may determine whether the current angular position θp recorded in the management table of the tone mark is within the operation determining range (180 degrees −β to 180 degrees+β). If the angular position θp is not within the operation determining range (“no” in S301), the determining units 21e and 21f terminate the processing in the current frame for the tone mark M.

If the angular position θp is within the operation determining range (“yes” in S301), the determining units 21e and 21f determine whether the tone output operation is performed (S302). For example, the second determining unit 21f determines whether a touch operation is performed on the operation area F2a of the second player area E2 with respect to the tone mark M moving on the lane L1a from the first player area E1 to the second player area E2. In contrast, the first determining unit 21e determines whether a touch operation is performed on the operation area F1a of the first player area E1 with respect to the tone mark M moving on the lane L2a from the second player area E2 to the first player area E1. The same processing is performed for the tone mark M moving in the other lane L.

If the tone output operation is not performed even though the tone mark M is within the operation determining range (“no” in S302), the point calculating unit 21k may subtract a predetermined point from the previously accumulated communication points (S303).

If the tone output operation is performed in S302 (“yes” in S302), the determining units 21e and 21f determine whether the angular position θp of the tone mark M is within the Perfect range (see FIG. 7) at the time when the tone output operation is performed (S304). If the tone mark M is within the Perfect range, the point calculating unit 21k refers to the point table in FIG. 10 and adds a point corresponding to the current balance level and the Perfect range to the previously accumulated communication points (S305).

If the tone mark M is not within the Perfect range (“no” in S304), the determining units 21e and 21f determine whether the angular position θp of the tone mark M is in the Nice range (see FIG. 7) at the time when the tone output operation is performed (S306). If the position θp of the tone mark M is within the Nice range, the point calculating unit 21k refers to the point table in FIG. 10 and adds a point corresponding to the current balance level and the Nice range to the communication points (S307).

If the tone mark M is not within the Nice range (“no” in S306), the point calculating unit 21k may refer to the point table in FIG. 10 and add a point corresponding to the current balance level and the Good range to the communication points (S308).

### [Modification of Communication Point Calculation]

The method for calculating the communication point is not limited to the example shown in FIG. 11.

For example, the count of the tone mark generating operations may be used to calculate the communication point. The point corresponding to the count of the tone mark generating operations may be added to the communication point in addition to the point corresponding to the count of the tone output operations.

The method of using the balance level is not limited to the example shown in FIG. 11. For example, the point calculating unit 21k may multiply a point determined for one tone output operation by a factor corresponding to the balance level and accumulate the result as the communication point. At this time, when the balance level is higher, a larger coefficient may be used.

When calculating the communication point, the point calculating unit 21k may not use the accuracy of the timing of performing the tone output operation. That is, the Perfect range N1, the Nice range N2, and the Good range N3 as shown in FIG. 7 may not be provided. In this case, only two ranges may be provided, i.e., a range in which the tone output operation is considered to be performed in response to the arrival of the tone mark M at the operation area F and a range other than such a range.

The evaluating unit 21C may not necessarily calculate the balance level in the processing for calculating the communication point. In order to calculate the communication point, the evaluating unit 21C may not calculate the balance level but use a difference or a ratio between a value corresponding to the count of operations (tone mark generating operation and/or tone output operation) of the first player P1 and a value corresponding to the count of operations (tone mark generating operation and/or tone output operation) of the second player P2. For example, the value based on such a difference (or ratio) may be multiplied by the count of tone output operations, and the result may be calculated as a communication point.

### [Communication Quantity Expressing Unit]

The communication quantity expressing unit 21D controls the background during a game based on the communication point. The background includes at least one of sound (music) that is output by the audio output unit 25 and an image (an object to be displayed) displayed on the display screen 10.

### [Controlling the Number of Tracks]

For example, as the communication points increase, the communication quantity expressing unit 21D may increase the number of tracks of the music that is output by the audio output unit 25. The storage unit 22 stores a plurality of tracks (audio data) constituting one musical piece. The tracks include a track of a drum set in charge of a rhythm, a track of a base guitar that supports a rhythm of a musical piece, and a track in charge of a portion of a main melody of the musical piece, for example.

The communication quantity expressing unit 21D may initially output a first track (e.g., a track of a drum set). The storage unit 22 stores a plurality of threshold values V1, V2, V3 . . . (V1<V2<V3< . . . ) in advance. The communication quantity expressing unit 21D may add a track every time a communication point calculated by the evaluating unit 21C exceeds the threshold value.

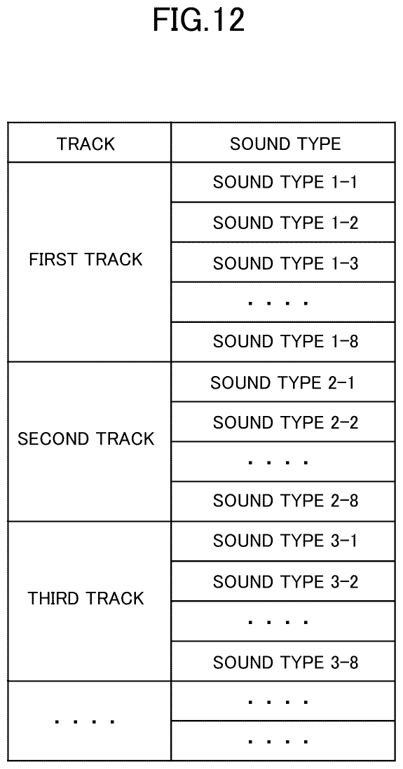

The storage unit 22 may store a plurality of sound types for each of the tracks. The sound types may be different in tones and musical instruments, for example. FIG. 12 is a diagram showing examples of sound types stored in the storage unit 22. In the examples shown in FIG. 12, sound types (1-1) to (1-8) are stored in the storage unit 22 as candidates for the first track, and sound types (2-1) to (2-8) are stored in the storage unit 22 as candidates for the second track. The same may be applied to the third track and the fourth track. The communication quantity expressing unit 21D may select one of the sound types when the communication point exceeds the threshold value described above, and add a track of the selected sound type.

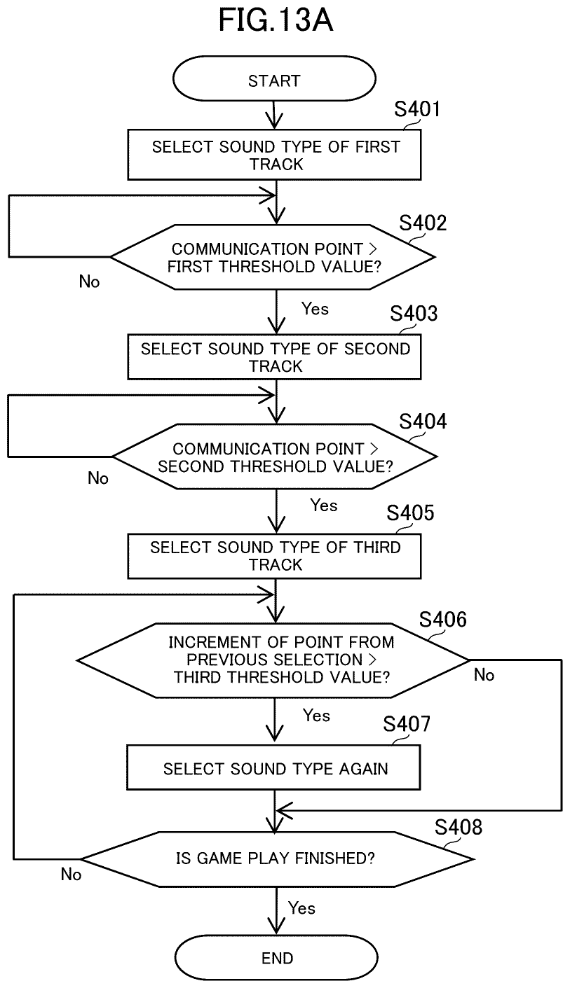

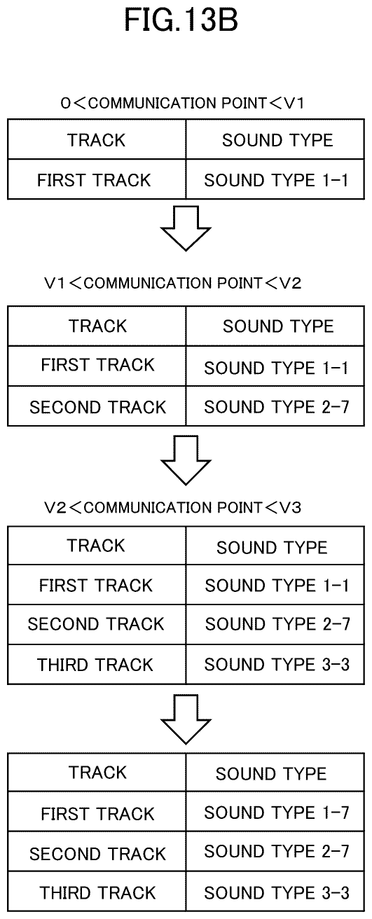

FIGS. 13A and 13B are diagrams showing the processing executed by the communication quantity expressing unit 21D. When the game starts, the communication quantity expressing unit 21D selects one of the sound types (audio data) stored in the storage unit 22 as a candidate for the first track, and outputs the selected sound type from the audio output unit 25 (S401). For example, as shown in FIG. 13B, the communication quantity expressing unit 21D selects a sound type 1-1 as the first track.

The communication quantity expressing unit 21D then determines whether the communication points exceed a first threshold value V1 (S402). The communication quantity expressing unit 21D repeatedly executes the processing of S402 until the communication points exceed the first threshold value V1. When the communication points exceed the first threshold value V1 (“yes” in S402), the communication quantity expressing unit 21D selects one of the sound types (audio data) stored in the storage unit 22 as a candidate for the second track, and outputs the selected sound type from the audio output unit 25 (S403). For example, as shown in FIG. 13B, the communication quantity expressing unit 21D selects a sound type 2-7 as the second track. The first track (sound type 1-1) and the second track (sound type 2-7) are then output from the audio output unit 25.

Next, the communication quantity expressing unit 21D determines whether the communication points exceed the second threshold value V2 (S404). The communication quantity expressing unit 21D repeatedly executes the processing of S404 until the communication points exceed the second threshold value V2. When the communication points exceed the second threshold value V2 (“yes” in S404), the communication quantity expressing unit 21D selects one of the sound types (audio data) stored in the storage unit 22 as a candidate for the third track, and outputs the selected sound type from the audio output unit 25 (S405). For example, as shown in FIG. 13B, the communication quantity expressing unit 21D selects a sound type 3-3 as the third track. The first track (sound type 1-1), the second track (sound type 2-7), and the third track (sound type 3-3) are then output from the audio output unit 25.

The communication quantity expressing unit 21D determines whether the increment of the communication points from the previous selection of the sound type (S405 or S407) exceeds a third threshold value V3 (S406). If the increment of the communication points exceeds the third threshold value V3 (“yes” in S406), the communication quantity expressing unit 21D selects the sound type again (S407).

Upon reaching the processing of S407, the communication quantity expressing unit 21D may each time select a sound type again in the order of the first track, the second track, and the third track. For example, as shown in FIG. 13B, the communication quantity expressing unit 21D changes the first track from the sound type 1-1 to the sound type 1-7. Upon reaching the processing of S407, the communication quantity expressing unit 21D may then change the second track from the sound type 2-7 to another sound type. Alternatively, the communication quantity expressing unit 21D may select a sound type again for all of the first to third tracks every time when reaching the processing of S407.

If the increment of the communication points does not exceed the third threshold value V3 in S406 (“no” in S406), the communication quantity expressing unit 21D determines whether the game is finished (S408). If the game is not finished, the communication quantity expressing unit 21D returns to S406 and executes the subsequent processing again. The communication quantity expressing unit 21D repeats the processing of S406 and S407 until the game is finished.

### [Control of Object Color]

For example, as the communication points increase, the communication quantity expressing unit 21D may increase color types of objects to be displayed on the display screen 10. For example, the communication quantity expressing unit 21D may increase at least one of hue, brightness, and saturation of the object in association with the increase in the communication points. The objects may include the tone mark M described above, for example. The display screen 10 may display a plurality of objects on the background of the tone mark M. In this case, the communication quantity expressing unit 21D may increase at least one of hue, brightness, and saturation of the object in association with the increase in the communication points.

The communication quantity expressing unit 21D initially displays the tone mark M generated by the first player P1 in a predetermined color (e.g., red 1), and displays the tone mark M generated by the second player P2 in another predetermined color (e.g., blue 1). The communication quantity expressing unit 21D may add a color of the tone mark M every time the communication points calculated by the evaluating unit 21C exceed the threshold value. For example, if the communication points exceed the first threshold value V1, the two tone marks M generated by the first player P1 may be displayed in two different colors (e.g., red 1 and red 2), and the two tone marks M generated by the second player P2 may be displayed in two different colors (e.g., blue 1 and blue 2).

The processing of the communication quantity expressing unit 21D is not limited to the examples described here.

For example, the communication quantity expressing unit 21D may display the communication points and the balance level while keeping the sound and the video (color of the object) constant.

### [Display Control of Elongated Tone Mark]

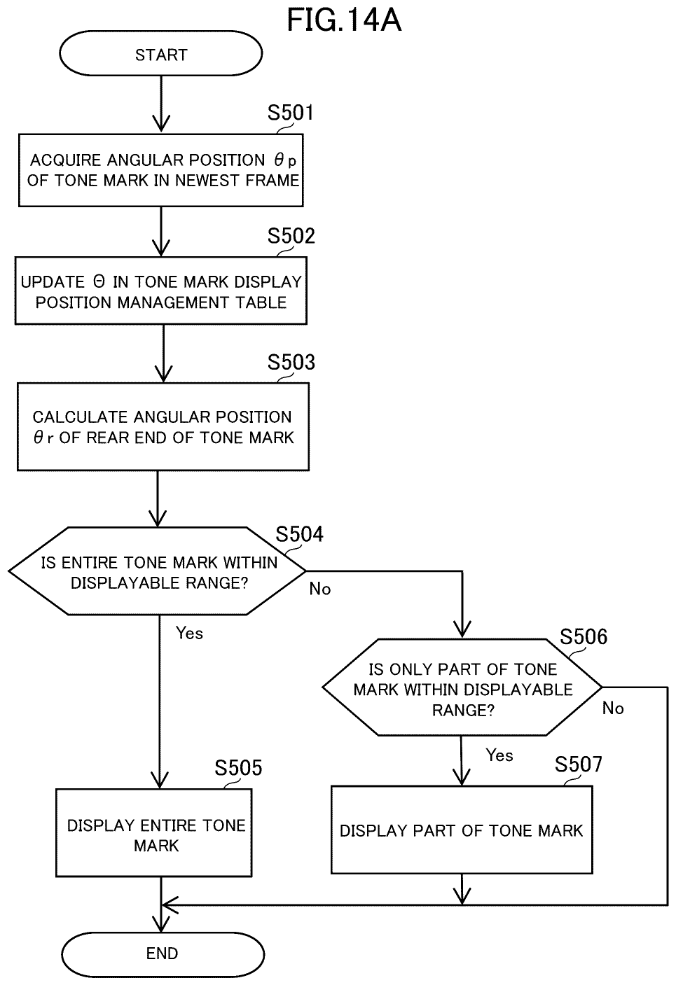

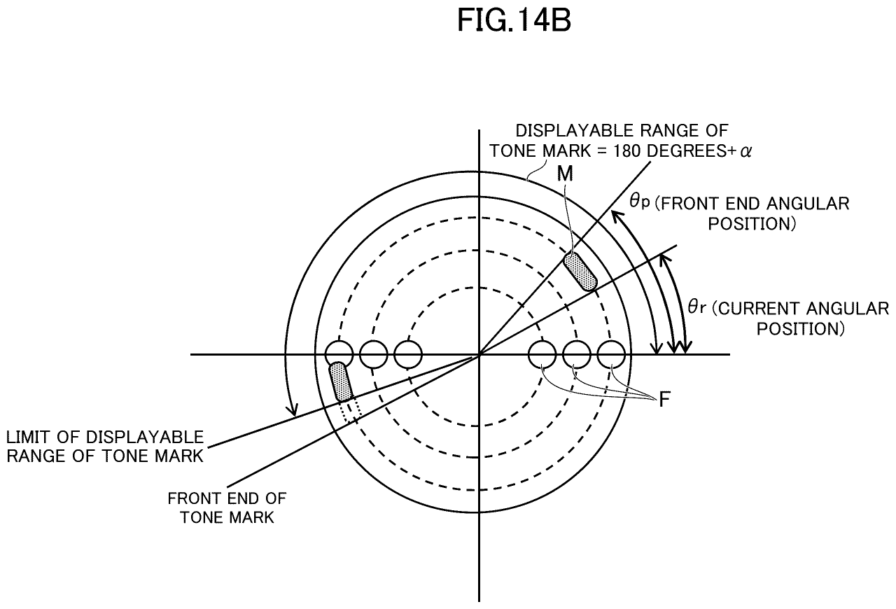

As described referring to FIG. 1C, the tone mark M may be elongated in the moving direction of the tone mark M. FIG. 14A is a flow chart showing an example of processing performed by the display control units 21a and 21b of the tone mark control unit 21A on such an elongated tone mark M. FIG. 14B is a diagram for illustrating such processing.

The display control units 21a and 21b refer to the management table (FIG. 5) of the tone marks and acquire the angular position θp of the tone mark M in the newest frame (S501). The angular position θp of the elongated tone mark M may be the angular position of the front end of the tone mark M. The display control units 21a and 21b add a predetermined angle (Δθ: an angle at which the tone mark M advances in one frame) to the angular position θp, and record the result of addition (θp+Δθ) as a new angular position θp in the management table (S502).

The display control units 21a and 21b may calculate an angular position θr (see FIG. 14B) of the rear end of the tone mark M (S503). A length (angular range Δθd) of each tone mark M is recorded in the management table shown in FIG. 5. As such, the display control units 21a and 21b may calculate an angular position θr of the rear end of the tone mark M by using the angle range Δθd and the updated angular position θp.

The display control units 21a and 21b determine whether the entire tone mark M is within the displayable range (S504). As described above, when the position in the player areas E1 and E2 in which the tone mark M is generated is 0 degrees, the displayable range may be 0 to 180 degrees+α, for example. As shown in FIG. 14B, the displayable range (0 to 180 degrees+α) is a range from the player area E1 (or E2) to the position of the opponent player past the player area E2 (or E1), for example. In S504, the display control units 21a and 21b may determine whether the angular position θp of the front end of the tone mark M is within the displayable range, for example.

When the entire tone mark M is within the displayable range (“yes” in S504), the display control units 21a and 21b display the entire tone mark M on the display screen 10 (S505).

On the other hand, when it is not recognized that the entire tone mark M is within the displayable range (“no” in S504), the display control units 21a and 21b determine whether only a part of the tone mark M is within the displayable range (S506). For example, the display control unit 21a and 21b may determine whether the angular position Or of the rear end of the tone mark M calculated in S503 is within the displayable range.

When only a part of the tone mark M is within the displayable range (“yes” in S506), the display control units 21a and 21b display only a part of the tone mark M within the displayable range on the display screen 10 (S507). For example, the display control units 21a and 21b may display the tone mark M between the limit position (180 degrees+α) of the displayable range and the angular position Or of the rear end of the tone mark M.

If the entire tone mark M is not within the displayable range (“no” in S506), the display control units 21a and 21b terminate the processing for the current frame without displaying the tone mark M on the display screen 10. If the entire tone mark M is not within the displayable range, the display control units 21a and 21b may remove the record of this tone mark M from the management table.

The display control units 21a and 21b perform the processing shown in FIG. 14A in each frame for each of the tone marks.

### [Processing for Point Calculation]

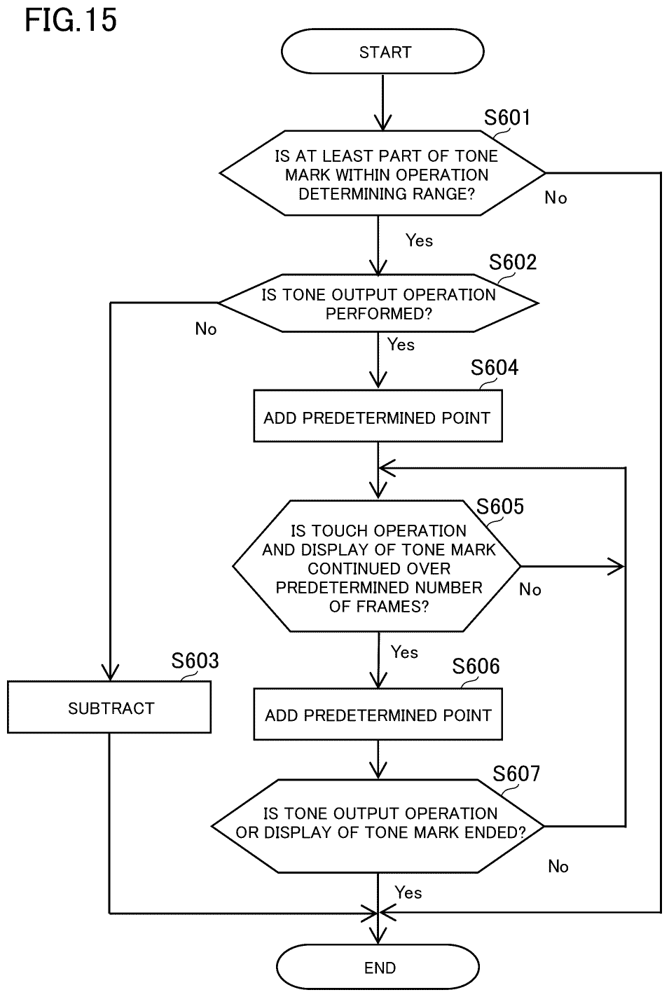

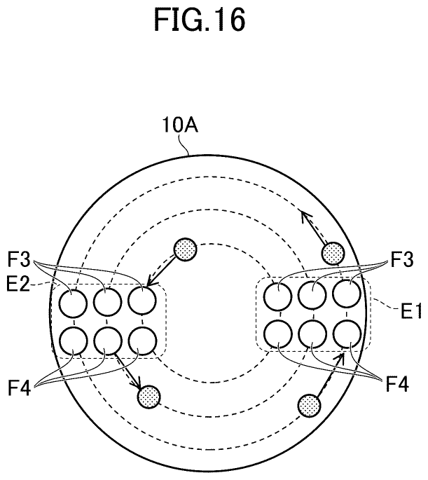

FIG. 15 is a flow chart showing an example of processing executed by the operation determining unit 21B and the evaluating unit 21C for the elongated tone mark M shown in FIG. 1C.

The determining units 21e and 21f refer to the tone mark management table (FIG. 5) and determine whether a part of the tone mark M is within the operation determining range (S601).

The operation determining range is a range in which whether a tone output operation is performed for the tone mark M is determined, and is a range combining the Good range, the Nice range, and the Perfect range shown in FIG. 7, for example. For example, the determining units 21e and 21f may determine whether the angular position θp of the front end of the tone mark M recorded in the management table is within the operation determining range (180 degrees-β to 180 degrees+β) and whether the angular position θr of the rear end of the tone mark M is within the operation determining range.

A length (angular range Δθd) of each tone mark M is recorded in the management table shown in FIG. 5. As described above, the angular position θr of the rear end of the tone mark M can be calculated using the angular range Δθd and the angular position θp of the front end.

If the tone mark M does not have a part positioned in the operation determining range (“no” in S601), the determining units 21e and 21f terminate the processing for the tone mark M in the current frame. On the other hand, if a part of the tone mark M is in the operation determining range (“yes” in S601), the determining units 21e and 21f determine whether the tone output operation is performed (S602). For example, the second determining unit 21f determines whether a touch operation is performed on the operation area F2a of the second player area E2 with respect to the tone mark M moving on the lane L1a from the first player area E1 to the second player area E2. In contrast, the first determining unit 21e determines whether a touch operation is performed on the operation area F1a of the first player area E1 with respect to the tone mark M moving on the lane L2a from the second player area E2 to the first player area E1.

If the tone output operation is not performed even though a part of the tone mark M is within the operation determining range (“no” in S602), the point calculating unit 21k may subtract a predetermined point from the previously accumulated communication points (S603).

If a tone output operation is performed in S602 (“yes” in S602), the determining units 21e and 21f add a predetermined point (S604). The point to be added may be determined according to the current balance level. For example, the point to be added in S604 may be set to a higher value when the balance level is higher (approaching the uppermost level).

Subsequently, the point calculating unit 21k may determine whether the tone output operation and the display of at least a part of the tone mark M have continued over a predetermined time period (over a predetermined number of frames) (S605). For example, the point calculating unit 21k may determine whether the time period (frame counts) in which a part of the tone mark M is displayed on the player areas E1 and E2 and the touch operation is performed, exceeds a predetermined value.

If the tone output operation and the display of the tone mark M continue for the period described above (“yes” in S605), the point calculating unit 21k may add a predetermined point (S606). The point calculating unit 21k determines whether one or both of the tone output operation and the display of the tone mark M have ended (S607). If the tone output operation and the display of the tone mark M continue (“no” in S607), the processing of the point calculating unit 21k returns to S604. In S605, if the time period in which the tone output operation and the display of the tone mark M are performed has not yet reached the predetermined time period (a predetermined number of frames), the processing of the point calculating unit 21k also returns to S604.

On the other hand, if one or both of the tone output operation and the display of the tone mark M have ended in S607, the determining units 21e and 21f terminate the processing for the tone mark M in the current frame.

### [Modification of Display Screen]

The entertainment system proposed in the present disclosure is not limited to the entertainment system 100 described above.

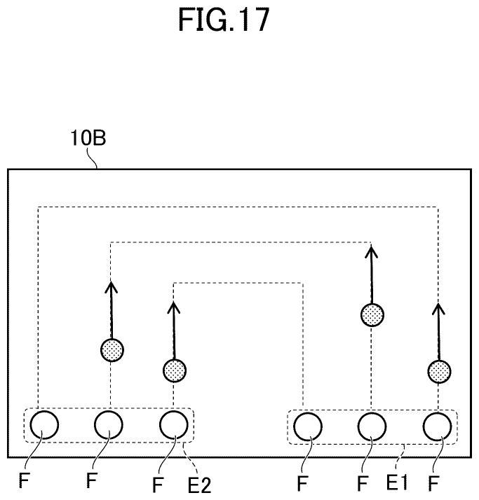

For example, the display screen 10 is not limited to the example shown in FIG. 1A, for example. FIGS. 16 and 17 are diagrams illustrating modifications of the display screen 10.

As shown in FIG. 16, the player areas E1 and E2 may each include an operation area F3 for receiving a tone mark generating operation and an operation area F4 for receiving a tone output operation in the display screen 10A. In this case, the player areas E1 and E2 may each include a plurality of operation areas F3 and a plurality of operation areas F4.

As shown in FIG. 17, the display screen 10B may be rectangular. In this case, a first player area E1 and a second player area E2 may be disposed on one side of the rectangle. In other words, the two player areas E1 and E2 may be adjacent to each other. In this case as well, the player areas E1 and E2 may each have a plurality of operation areas F. In this case as well, a lane in which the tone mark M moves may be provided between the two corresponding operation areas F. In the example shown in FIG. 17, three lanes L1, L2, and L3 are provided.

### CONCLUSION

(1) An entertainment system 100 includes a first display control unit 21a that generates a tone mark M on display screens 10, 10A, and 10B in response to a tone mark generating operation by a first player P1 and moves the tone mark M toward a second player area E2 provided on the display screens 10, 10A, and 10B, a second display control unit 21b that generates a tone mark M on the display screens 10, 10A, and 10B in response to a tone mark generating operation by a second player P2 and moves the tone mark M toward a first player area E1 provided on the display screens 10, 10A, and 10B, a first determining unit 21e that determines whether the first player P1 performs a tone output operation at a time when the tone mark M generated by the second player P2 arrives at the first player area E1, a second determining unit 21f that determines whether the second player P2 performs a tone output operation at a time when the tone mark M generated by the first player P1 arrives at the second player area E2, and an evaluating unit 21C that calculates an amount of communication points based on at least one of the tone mark generating operation or the tone output operation by the first player P1 and at least one of the tone mark generating operation or the tone output operation by the second player P2.

According to the entertainment system 100, the tone mark M generated by the first player P1 moves to the second player area E2 and the tone mark M generated by the second player P2 moves to the first player area E1. This allows, for example, the second player P2 to feel the rhythm of the movement of the first player P1 (generation of the tone mark M) and the first player P1 to feel the rhythm of the movement of the second player P2 (generation of the tone mark M). This enables communication between the first player P1 and the second player P2 via the tone mark M.

(2) The entertainment system 100 of (1) further includes a communication quantity expressing unit 21D that controls a background including at least one of sound or video based on the communication point, where the sound is output from an audio output unit 25 and the video is displayed on the display screens 10, 10A, and 10B. This enables the two players to feel a change in sound or video, thereby recognizing good communication.

(3) In the entertainment system 100 of (1) or (2), the tone mark generating operation by the first player P1 is a touch operation on the first player area E1, and the tone mark generating operation by the second player P2 is a touch operation on the second player area E2.

(4) In the entertainment system 100 according to any one of (1) to (3), the tone output operation by the first player P1 is a touch operation on the tone mark M that arrives at the first player area E1, and the tone output operation by the second player P2 is a touch operation on the tone mark M that arrives at the second player area E2.

(5) In the entertainment system 100 according to any one of (1) to (4), the evaluating unit 21C compares at least one of the tone mark generating operation or the tone output operation by the first player P1 and at least one of the tone mark generating operation or the tone output operation by the second player P2, and calculate the communication points based on a result of the comparison. In this manner, the communication point can be increased when the movements (operations) of the two players P1 and P2 are balanced, and the communication can be appropriately evaluated.

(6) In the entertainment system 100 according to any one of (1) to (5), the evaluating unit 21C calculates the communication points based on a difference or a ratio between a value (including count itself) corresponding to a count of at least one of the tone mark generating operation or the tone output operation by the first player P1 and a value (including count itself) corresponding to a count of at least one of the tone mark generating operation and the tone output operation by the second player P2. In this manner, the communication point can be increased when the movements (operations) of the two players P1 and P2 are balanced, and the communication can be appropriately evaluated.

(7) In the entertainment system 100 of (5) or (6), the at least one of the tone mark generating operation or the tone output operation is the tone mark generating operation.

(8) In the entertainment system 100 according to (6), the count regarding the first player P1 may be a count of the at least one of operations performed by the first player P1 in a period from a predetermined period of time before a current time, to the current time (operation counting period), and the count regarding the second player P2 may be a count of the at least one of operations performed by the second player P2 in the operation counting period. In this manner, the two players are motivated to actively generate tone marks throughout the game, and thus decrease in communication frequency can be prevented.

(9) In the entertainment system 100 according to any one of (6) to (8), the evaluating unit 21C increases the communication points as the count of the tone output operation by the first player P1 and the count of the tone output operation by the second player P2 each increase. This enables counting the tone output operation as a communication success.

(10) In the entertainment system 100 according to (6), the evaluating unit 21C includes a balance evaluating unit 21i and a point calculating unit 21k. The balance evaluating unit 21i calculates a balance level based on the result of comparing the operations of the two players. The point calculating unit 21k calculates the communication point based on the balance level, the count of the tone output operation by the first player P1, and the count of the tone output operation by the second player P2. In this manner, the communication point can be increased when the movements (operations) of the two players P1 and P2 are balanced and the count of the tone output operation by the two players P1 and P2 is large. This serves to appropriately evaluate the communication.

(11) In the entertainment system 100 according to (10), the balance level calculated by the balance evaluating unit 21i is higher when a difference between the count of the at least one of the tone mark generating operation and the tone output operation by the first player P1 and the count of the at least one of the tone mark generating operation and the tone output operation by the second player P2 is smaller.

(12) In the entertainment system 100 according to any one of (1) to (11), the first player area E1 includes at least a first operation area F1a and a second operation area F1b, and the second player area E2 includes at least a third operation area F2a and a fourth operation area F2b. The first display control unit 21a generates a first tone mark M1a in response to the tone mark generating operation on the first operation area Fla and generates a second tone mark M1b in response to the tone mark generating operation on the second operation area Fib. The second display control unit 21b generates a third tone mark M2a in response to the tone mark generating operation on the third operation area F2a and generates a fourth tone mark M2b in response to the tone mark generating operation on the fourth operation area F2b. This allows each of the player areas E1 and E2 to include a plurality of operation areas F, thereby increasing the amount of communication between the two players P1 and P2.

(13) In the entertainment system 100 according to any one of (1) to (12), the first player area E1 includes at least a first operation area F1a and a second operation area F1b, and the second player area E2 includes at least a third operation area F2a and a fourth operation area F2b. The first display control unit 21a generates a first tone mark M1a in response to the tone mark generating operation on the first operation area Fla, moves the first tone mark M1a toward the third operation area F2a of the second player area E2, generates a second tone mark M1b in response to the tone mark generating operation on the second operation area F1b, and moves the second tone mark M1b toward the fourth operation area F2b of the second player area E2. In this manner, a movement route of the tone mark from the first player area to the second player area is limited, and thus the movement of the tone mark is simplified and the tone output operation required for the second player P2 can be facilitated.

(14) In the entertainment system 100 according to (13), the second display control unit 21b generates a third tone mark M2b in response to the tone mark generating operation on the third operation area F2a, moves the third tone mark M2a toward the first operation area F1a of the first player area E1, generates a fourth tone mark M2b in response to the tone mark generating operation on the fourth operation area F2b, and moves the fourth tone mark M2b toward the second operation area Fib of the first player area E1. In this manner, a movement route of the tone mark from the second player area to the first player area is limited, and thus the movement of the tone mark is simplified and the tone output operation required for the first player P1 can be facilitated.

(15) In the entertainment system 100 according to any one of (1) to (14), the first display control unit 21a moves the tone mark M along first lanes L1a to L1c from the first player area E1 to the second player area E2, and the second display control unit 21b moves the tone mark M along second lanes L2a to L2c from the second player area E2 to the first player area E1. The first lanes L1a to L1c and the second lanes L2a to L2c are defined so as to be opposed to each other across a center line of the display screens 10 and 10A. In this manner, the tone mark M from the first player area E1 to the second player area E2 is not mixed with the tone mark M from the second player area E2 to the first player area E1. This enables the two players P1 and P2 to easily recognize the tone mark M approaching their player areas.

What is claimed is:

1. An entertainment system, comprising at least one processor configured to:
generate a tone mark on a display screen in response to a tone mark generating operation by a first player and move the tone mark toward a second player area provided on the display screen;
generate a tone mark on the display screen in response to a tone mark generating operation by a second player and move the tone mark toward a first player area provided on the display screen;
determine whether the first player performs a tone output operation at a time when the tone mark generated by the second player arrives at the first player area;
determine whether the second player performs a tone output operation at a time when the tone mark generated by the first player arrives at the second player area; and
calculate an amount of communication points based on at least one of the tone mark generating operation or the tone output operation by the first player and at least one of the tone mark generating operation or the tone output operation by the second player.

2. The entertainment system according to claim 1, wherein the at least one processor is configured to control a background including at least one of sound or video based on the communication point, the sound being output from an audio output unit, the video being displayed on the display screen.

3. The entertainment system according to claim 1, wherein
the tone mark generating operation by the first player is a touch operation on the first player area, and
the tone mark generating operation by the second player is a touch operation on the second player area.

4. The entertainment system according to claim 1, wherein
The tone output operation by the first player is a touch operation on the tone mark that arrives at the first player area, and
The tone output operation by the second player is a touch operation on the tone mark that arrives at the second player area.

5. The entertainment system according to claim 1, wherein the at least one processor is configured to compare the at least one of the tone mark generating operation or the tone output operation by the first player and the at least one of the tone mark generating operation or the tone output operation by the second player, and calculate the communication points based on a result of the comparison.

6. The entertainment system according to claim 1, wherein the at least one processor is configured to calculate the communication points based on a difference or a ratio between a value corresponding to a count of the at least one of the tone mark generating operation or the tone output operation by the first player and a value corresponding to a count of the at least one of the tone mark generating operation and the tone output operation by the second player.

7. The entertainment system according to claim 5, wherein
the at least one of the tone mark generating operation or the tone output operation is the tone mark generating operation.

8. The entertainment system according to claim 6, wherein
the count regarding the first player is a count of the at least one of operations performed by the first player in a period from a predetermined period of time before a current time, to the current time, and
the count regarding the second player is a count of the at least one of operations performed by the second player in a predetermined period of from a past point in time to the current time.

9. The entertainment system according to claim 6, wherein the at least one processor is configured to increase the communication point as the count of the tone output operation by the first player and the count of the tone output operation by the second player each increase.

10. The entertainment system according to claim 5, wherein the at least one processor is configured to:
calculate a balance level based on the comparison result, and
calculate the communication point based on the balance level, the count of the tone output operation by the first player, and the count of the tone output operation by the second player.

11. The entertainment system according to claim 10, wherein
the balance level is higher when a difference between the count of the at least one of the tone mark generating operation and the tone output operation by the first player and the count of the at least one of the tone mark generating operation and the tone output operation by the second player is smaller.

12. The entertainment system according to claim 1, wherein
the first player area includes at least a first operation area and a second operation area,
the second player area includes at least a third operation area and a fourth operation area, and
wherein the at least one processor is configured to:
generate a first tone mark in response to the tone mark generating operation on the first operation area and generate a second tone mark in response to the tone mark generating operation on the second operation area, and
generate a third tone mark in response to the tone mark generating operation on the third operation area and generate a fourth tone mark in response to the tone mark generating operation on the fourth operation area.

13. The entertainment system according to claim 1, wherein
the first player area includes at least a first operation area and a second operation area,
the second player area includes at least a third operation area and a fourth operation area, and
wherein the at least one processor is configured to generate a first tone mark in response to the tone mark generating operation on the first operation area, move the first tone mark toward the third operation area of the second player area, generate a second tone mark in response to the tone mark generating operation on the second operation area, and move the second tone mark toward the fourth operation area of the second player area.

14. The entertainment system according to claim 13, wherein the at least one processor is configured to generate a third tone mark in response to the tone mark generating operation on the third operation area, move the third tone mark toward the first operation area of the first player area, generate a fourth tone mark in response to the tone mark generating operation on the fourth operation area, and move the fourth tone mark toward the second operation area of the first player area.

15. The entertainment system according to claim 1, wherein the at least one processor is configured to:
move the tone mark along a first lane from the first player area to the second player area,
move the tone mark along a second lane from the second player area to the first player area, and
wherein
the first lane and the second lane are defined so as to be opposed to each other across a center line of the display screen.

16. A non-transitory information storage medium having stored thereon a program for causing a computer to:
generate a tone mark on a display screen in response to a tone mark generating operation by a first player and move the tone mark toward a second player area provided on the display screen;
generate a tone mark on a display screen in response to a tone mark generating operation by a second player and move the tone mark toward a first player area provided on the display screen;
determine whether the first player performs a tone output operation at a time when the tone mark generated by the second player arrives at the first player area;
determine whether the second player performs a tone output operation at a time when the tone mark generated by the first player arrives at the second player area; and
calculate an amount of communication points based on at least one of the tone mark generating operation or the tone output operation by the first player and at least one of the tone mark generating operation or the tone output operation by the second player.

17. A method for controlling an entertainment system comprising the steps of:
generating a tone mark on a display screen in response to a tone mark generating operation by a first player and moving the tone mark toward a second player area provided on the display screen;
generating a tone mark on a display screen in response to a tone mark generating operation by a second player and moving the tone mark toward a first player area provided on the display screen;
determining whether the first player performs a tone output operation at a time when the tone mark generated by the second player arrives at the first player area;
determining whether the second player performs a tone output operation at a time when the tone mark generated by the first player arrives at the second player area; and
calculating an amount of communication points based on at least one of the tone mark generating operation or the tone output operation by the first player and at least one of the tone mark generating operation or the tone output operation by the second player.
